(19) United States
(12) Patent Application Publication
(10) Pub. No.: US 2015/0023054 A1
(43) Pub. Date: Jan. 22, 2015

(54) REFLECTIVE FILM

(71) Applicant: Toray Industries, Inc., Chuo-ku, Tokyo (JP)

(72) Inventors: Wataru Goda, Otsu (JP); Shigetoshi Maekawa, Otsu (JP); Syunichi Osada, Otsu (JP); Kozo Takahashi, Otsu (JP); Hitomi Furukawa, Otsu (JP); Teruya Tanaka, Otsu (JP)

(21) Appl. No.: 14/378,395

(22) PCT Filed: Feb. 12, 2013
(86) PCT No.: PCT/JP2013/053183

§ 371 Date: Aug. 13, 2014

(30) Foreign Application Priority Data
Feb. 13, 2012 (JP) 2012-027998

(51) Int. Cl. G02B 5/08; F21V 8/00

(52) U.S. Cl. CPC G02B 5/0841; G02B 6/0033
USPC 362/607; 359/584

(57) ABSTRACT

A reflective film includes a first section in which a layer including a resin A and a layer including a resin B are alternately laminated in 200 layers or more, and a second section including a resin C which meets at least one of (I) to (III), the sections arranged laminatedly in the thickness direction, wherein relative average reflectance at a wavelength of 400 to 700 nm of light incident upon the first section side arranged laminatedly is 70% or more, and the reflectance of a specular reflection component is 10% or more of the relative average reflectance:
(I) voidage in the second section is 5% to 90%;
(II) content of inorganic particles in the second section is 5% to 50% by mass; and
(III) content of organic particles in the second section is 3% to 45% by mass.

### TECHNICAL FIELD

This disclosure relates to a reflective film in which a diffuse reflection component is controlled.

### BACKGROUND

In recent years, illumination light sources have made a significant shift from conventional fluorescent light bulbs and incandescent lamps to light emitting diodes (LED) characterized by low power consumption, long life, and space saving. In this trend, according to consumer preferences, there have been demands for variety in lighting design of residential lighting, automobile lighting, mobile equipment lighting, signboard lighting, liquid crystal display lighting, illumination lighting, and the like. In such lighting, the material necessary to guide light from an illuminant effectively in a designed direction is a reflective member. The reflective member takes various forms such as planar and three-dimensional curved shapes depending on the lighting design. For its reflective performance, there have been demands for higher reflectance from the standpoint of low power consumption, control of the directivity of light from the standpoint of lighting design and, further, moldability that allows for three-dimensional conformability to the shape of cavities in a lighting apparatus from the standpoint of low cost.

There are roughly two types of films conventionally known having reflective performance. One is a white film which diffusely reflects most of incident light, and the other is a mirror reflective film which specularly reflects most of incident light. As the white film, one which is obtained by adding a high concentration of inorganic particles of, for example, barium sulfate, titanium oxide, or calcium carbonate mainly into a polyester film, and such a structure that innumerable bubbles (voids) are provided inside a polyester film are known (JP 2006-284689 A (page 2) and JP 2005-125700 A (section 2)). The former white film tears easily due to the particles, and thus has poor moldability. The latter white film has good moldability, but in view of curling properties and low stiffness, a high concentration of inorganic particles are added to its outer layer. On the other hand, as the mirror reflective film, a metallized film obtained by depositing a metal, mainly, silver, aluminum, or the like, on a film surface, or a multilayer film using optical interference, in which resins having a different refractive index are alternately laminated in 1000 layers or more at an optical wavelength level, are known (JP 2002-117715 A (page 2) and JP 11-508702 W (page 2)).

The white film, in which diffuse reflection is dominant in principle, is not appropriate for applications requiring strong specular reflection. This is because light diffuses excessively, and in design of lighting, light cannot be guided to places where brightness is required, leading to significant light loss and poor lighting designability. Surface planarization has been conventionally used as a means to improve specular reflectivity, but it has not produced a significant improvement effect. On the other hand, in the mirror reflective film, specular reflection is dominant, and surface roughening has been used as a means to improve diffusibility. However, a mat tone (whitishness) is likely to appear, causing a problem of loss of a glossy texture. In particular, the metallized film has a problem in that it is unsuitable for molding due to rust, cracking, and the like. It has also been proposed that an optically thick layer such as a light guide plate or diffusion element is disposed adjacent to a multilayer film to guide light emitted from a light source to the optically thick layer, thereby providing a high reflectance. However, the design of the light guide plate is intended for uniform light propagation throughout the plane, and the propagation distance is long, which causes light loss due to light absorption. To take light out of the plane, a very complicated optical design is required (JP 2009-532720 W (page 2)).

As described above, hitherto there has been no reflective film that maintains high glossiness, while controlling the directivity of reflected light such that the relationship between specular reflectivity and diffuse reflectivity is significantly changed with ease. Thus, there is a need to maintain high glossiness, provide high directivity of reflected light, and provide high brightness when used as a reflecting plate in displays or the like as well as to exhibit excellent moldability during molding.

### SUMMARY

We thus provide:

(1) A reflective film, comprising:

a first section in which a layer comprising a resin A (A layer) and a layer comprising a resin B (B layer) are alternately laminated in 200 layers or more; and

a second section comprising a resin C which meets at least one of the following requirements (I) to (III), the two sections being arranged laminatedly in the thickness direction, wherein the relative average reflectance at a wavelength of 400 to 700 nm of light incident upon the first section side of the film arranged laminatedly is 70% or more, and the reflectance of a specular reflection component is 10% or more of the relative average reflectance at a wavelength of 400 to 700 nm:

(I) the voidage in the second section is 5% to 90%;

(II) the content of inorganic particles in the second section is 5% by mass to 50% by mass; and

(III) the content of organic particles in the second section is 3% by mass to 45% by mass.

(2) The reflective film according to (1), wherein when two reflective films are arranged such that the first section and the second section are laminated, the rate of change in surface roughness Ra of the first section before and after aging treatment at 60° C. for 24 hr under a load of 2 MPa is less than 100%.

(3) The reflective film according to any one of (1) to (3), comprising a transparent layer provided between the first section and the second section arranged laminatedly, the transparent layer being a transparent adhesive layer having a thickness of 0.5 μm to 10 μm and a refractive index equal to or lower than the refractive index of air or of layers each forming an interface with the first section and the second section in contact with the transparent layer.

(4) The reflective film according to any one of (1) to (3), wherein a wavelength range where the reflectance of light incident upon the surface at the first section side is higher than the reflectance of light incident upon the surface at the second section side exists in the visible-light region.

(5) The reflective film according to any one of (1) to (4), wherein the surface roughness of the first section and the surface roughness of the second section at the interface arranged laminatedly are 20 nm or less and 35 nm or less, respectively.

(6) The reflective film according to any one of (1) to (5), wherein the second section has a three-layer structure in which the inner layer is a diffuse reflection layer, and outer layers have a thickness of 5 μm or more.

(7) The reflective film according to any one of (1) to (6), wherein one of the outermost layers of the first section has a thickness of 5 μm or more.

(8) The reflective film according to any one of (1) to (7), wherein the resin A comprises polyethylene terephthalate or polyethylene naphthalate.

(9) The reflective film according to any one of (1) to (8), wherein the resin A or the resin B is decalin acid copolyester.

(10) The reflective film according to any one of (1) to (9), wherein the resin C comprises polyethylene terephthalate and/or polyethylene terephthalate copolymer.

(11) The reflective film according to any one of (1) to (10), comprising the first section and the second section, wherein the reflectance in the first section in a wavelength range of 400- to 700-nm reflection band is higher than the reflectance in the second section in a wavelength range of 400- to 700-nm reflection band.

(12) The reflective film according to any one of (1) to (11), having a lightness L* (SCE) of 22 to 70.

(13) The reflective film according to any one of (1) to (12), having an absolute reflectance of 95% or more in a wavelength range of either 450 nm±30 nm or 550 nm±30 nm under conditions of a light incidence angle of 30° or more but less than 90°.

(14) A reflecting plate for a liquid crystal display including the reflective film according to any one of (1) to (13).

(15) An LCD backlight system comprising an LED light source, a reflective film, a light guide plate, a light diffusing sheet, and a prism sheet, wherein the reflective film according to any one of (1) to (13) is used which has an absolute reflectance of 95% or more at a light incidence angle of 30° or more but less than 90° at a wavelength of a blue emission spectrum from the LED light source.

We provide a reflective film having high glossiness and in which a specular reflection component and a diffuse reflection component of light is controlled. We also provide a reflective film having improved reflectance and improved brightness due to a synergistic effect of interference reflection and diffuse reflection, can be three-dimensionally molded, and can be used for a cavity in various lighting applications. We particularly provide a reflective film used in LCD backlight systems.

### BRIEF DESCRIPTION OF THE DRAWINGS

FIGS. 1(a) and 1(b) are a schematic view of a reflective film in which a diffuse reflection component is controlled.

FIGS. 2(a)-2(d) explain one example of the method of producing the first section. 2(a) is a schematic front view of an apparatus, and 2(b), 2(c), and 2(d) are cross-sectional views of a resin flow path taken along L-L′, M-M′, and N-N′, respectively.

FIG. 3 shows an example of the relationship between layer sequence and layer thickness (layer thickness distribution) of the first section.

FIGS. 4(a)-4(c) show examples of lighting systems including the reflective film.

FIGS. 5(a) and 5(b) show examples of backlight systems including the reflective film.

FIG. 6 shows an example of the reflective film that is perforated.

FIGS. 7(a) and 7(b) show a spectral reflectance curve of the reflective film of Example 9.

FIG. 8 is a spectral reflectance curve of reflective film of Comparative Example 3.

FIG. 9 is an angle-adjustable absolute reflectance curve of the laminated film used as the first section constituting the reflective film of Example 9.

### DESCRIPTION OF SYMBOLS

1: First section (laminated film)
1-1: Surface of first section opposite to second section
1-2: Another surface of first section (surface of reflective film)
2: Second section (white film)
2-1: Surface of second section opposite to first section
2-2: Another surface of second section (surface of reflective film)
3: Reflective film
4: Light from light source
5: Specular reflection
6: Diffuse reflection
7: Laminating apparatus
71: Slit plate
72: Slit plate
73: Slit plate
8: Combiner
9: Connecting pipe
10: Die
11: Slant structure of layer thickness formed by slit plate 71
12: Slant structure of layer thickness formed by slit plate 72
13: Slant structure of layer thickness formed by slit plate 73
11L: Resin flow path from outlet of slit plate 71
12L: Resin flow path from outlet of slit plate 72
13L: Resin flow path from outlet of slit plate 73
11M: Resin flow path that is in communication with outlet of slit plate 71 and arranged by recombiner
12M: Resin flow path that is in communication with outlet of slit plate 72 and arranged by combiner
13M: Resin flow path that is in communication with outlet of slit plate 73 and arranged by combiner
14: Length of resin flow path in width direction
15: Length in film width direction at inlet of die
16: Cross-section of flow path at die inlet
17: Length of die lip in film width direction
18: Layer sequence
19: Layer thickness
20: Point indicating thickness of thick-film layer
21: Layer thickness distribution of resin A
22: Layer thickness distribution of resin B
23: LED light source
24: Prism sheet
25: Diffuser sheet
26: Diffuser plate
27: Fluorescent light bulb
28: Light guide plate
29: Example of reflective film subjected to punching process
30: Transparent adhesive layer (transparent layer)
40: Spectral reflectance curve of the first section constituting the reflective film of Example 9
41: Spectral reflectance curve of the second section constituting the reflective film of Example 9
42: Spectral reflectance curve obtained when light is incident upon the first section side of the reflective film of Example 9
43: Spectral reflectance curve obtained when light is incident upon the second section side of the reflective film of Example 9
44: Spectral reflectance curve obtained when light is incident upon the first section side of the reflective film of Comparative Example 3
45: Spectral reflectance curve of the first section alone constituting the reflective film of Comparative Example 3
46: Spectral reflectance curve of the second section alone constituting the reflective film of Comparative Example 3
47: Absolute reflectance curve of the laminated film alone of Example 9 at incidence angle of 20°
48: Absolute reflectance curve of the laminated film alone of Example 9 at incidence angle of 40°
49: Absolute reflectance curve of the laminated film alone of Example 9 at incidence angle of 60°
50: Intensity distribution (absolute reflectance curve) of general white LED illumination light

### DETAILED DESCRIPTION

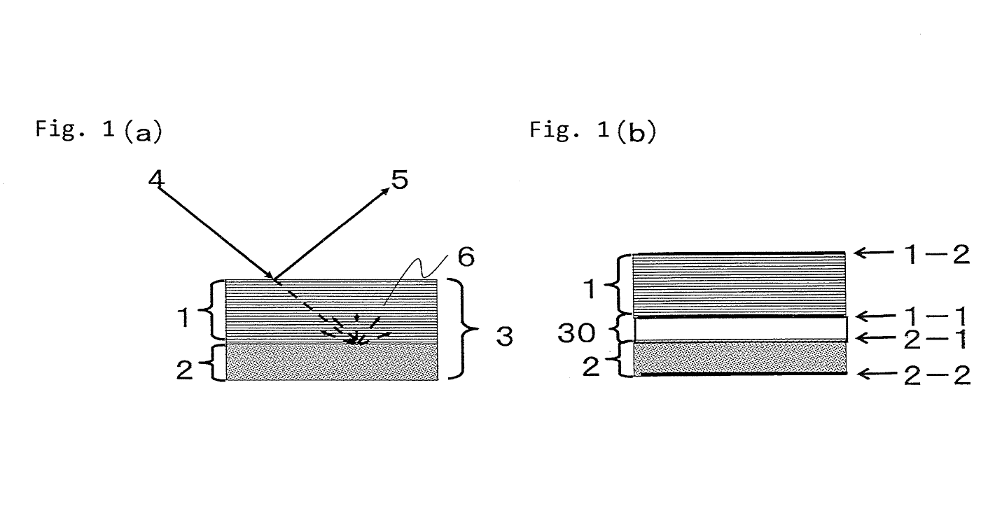

Our films will be described below. FIG. 1 shows an example of configurations of our reflective films. In a reflective film 3, a first section 1 in which a layer comprising a resin A (A layer) and a layer comprising a resin B (B layer) are alternately laminated in 200 layers or more and a second section 2 comprising a resin C which meets at least one of the following requirements (I) to (III) are arranged laminatedly in the thickness direction.

(I) The voidage in the second section is 5% to 90%.

(II) The weight concentration of inorganic particles in the second section is 5% by mass to 50% by mass.

(III) The weight concentration of organic particles in the second section is 3% by mass to 45% by mass.

Examples of the resins A and B that can be suitably used include linear polyolefins such as polyethylene, polypropylene, poly(4-methylpentene-1), and polyacetal; alicyclic polyolefins such as ring-opened metathesis polymers, addition polymers, and addition copolymers with other olefins of norbornenes; biodegradable polymers such as polylactic acid and polybutyl succinate; polyamides such as nylon 6, nylon 11, nylon 12, and nylon 66; aramids; polymethyl methacrylate; polyvinyl chloride; polyvinylidene chloride; polyvinyl alcohol; polyvinyl butyral; ethylene vinyl acetate copolymer; polyacetal; polyglycolic acid; polystyrene; styrene acrylonitrile copolymer; styrene polymethyl methacrylate copolymer; polycarbonate; polyesters such as polypropylene terephthalate, polyethylene terephthalate, polybutylene terephthalate, and polyethylene-2,6-naphthalate; polyether sulfone; polyether ether ketone; modified polyphenylene ether; polyphenylene sulfide; polyetherimide; polyimide; polyarylate; tetrafluoroethylene resin; trifluoroethylene resin; trifluorochloroethylene resin; tetrafluoroethylene-hexafluoropropylene copolymer; and polyvinylidene fluoride. Among them, polyesters are particularly preferably used from the standpoint of good extrusion moldability, strength, heat resistance, transparency, and versatility. These may be a homopolymer, a copolymer, or a mixture.

A preferred polyester is a polyester obtained by polymerization of monomers composed mainly of an aromatic dicarboxylic acid or aliphatic dicarboxylic acid and a diol. Examples of aromatic dicarboxylic acids include terephthalic acid, isophthalic acid, phthalic acid, 1,4-naphthalene dicarboxylic acid, 1,5-naphthalene dicarboxylic acid, 2,6-naphthalene dicarboxylic acid, 4,4′-diphenyldicarboxylic acid, 4,4′-diphenyl ether dicarboxylic acid, and 4,4′-diphenyl sulfone dicarboxylic acid. Examples of aliphatic dicarboxylic acids include adipic acid, suberic acid, sebacic acid, dimer acid, dodecanedioic acid, cyclohexanedicarboxylic acid, decalin acid, and ester derivatives thereof. In particular, terephthalic acid and 2,6-naphthalene dicarboxylic acid, which exhibit a high refractive index, are preferred. These acid components may be used alone or in combination of two or more thereof, and further, hydroxy acids such as hydroxybenzoic acid may be partially copolymerized.

Examples of diol components include ethylene glycol, 1,2-propanediol, 1,3-propanediol, neopentyl glycol, 1,3-butanediol, 1,4-butanediol, 1,5-pentanediol, 1,6-hexanediol, 1,2-cyclohexanedimethanol, 1,3-cyclohexanedimethanol, 1,4-cyclohexanedimethanol, diethylene glycol, triethylene glycol, polyalkylene glycol, 2,2-bis(4-hydroxyethoxyphenyl)propane, isosorbate, and spiroglycol. In particular, ethylene glycol is preferably used. These diol components may be used alone or in combination of two or more thereof.

Among the polyesters above, to exhibit a high reflectance, the resin A used in the first section is preferably polyethylene terephthalate, polyethylene naphthalate, polybutylene terephthalate, polybutylene naphthalate, polyhexamethylene terephthalate, or polyhexamethylene naphthalate because they can be provided with orientational crystallization by biaxial stretching and heat treatment, and particularly preferably polyethylene terephthalate or polyethylene naphthalate in view of versatility and moldability. Oriented crystallization induces the increase in refractive index and provides high heat resistance and high stiffness. For the resin B used in the first section, copolymers thereof are preferably used in order to prevent poor appearance such as flow marks due to delamination and disturbed lamination. Further, for the resin C used in the second section, polyethylene terephthalate, polyethylene naphthalate, and copolymers and alloys thereof are preferably used from the standpoint of versatility and ease of formation of voids resulting from particles.

A laminated film in which a layer comprising a resin A (A layer) and a layer comprising a resin B (B layer) are alternately laminated in 200 layers or more is used as the first section constituting the reflective film of the present invention. This can be produced using a laminating apparatus disclosed in Japanese Patent No. 4552936. However, the clearance and the length of a slit plate are varied as appropriate depending on the layer thickness to be designed. In other words, resulting laminated films have different layer thickness distributions, and the thickness of each layer and the arrangement of the layers are different from those disclosed in the document.

It is necessary that the relative average reflectance at a wavelength of 400 to 700 nm of the total of a specularly reflected light 5 and a diffuse reflected light 6 be 70% or more relative to a light 4 incident from a light source shown in FIG. 1 upon the first section, and among the reflected light of the light 4 incident upon the first section side, the reflectance of a specular reflection component be 10% or more of the relative average reflectance at a wavelength of 400 to 700 nm. The reflective film is desirably used in a structure where light is incident upon the first section side, which is from the standpoint of maintaining high glossiness. When light is incident upon the second section side, the average reflectance at a wavelength of 400 to 700 nm depends upon diffuse reflection of a white film used as the second section, resulting is no glossiness. Further, it is difficult to take out the reflected light at the first section, thus failing to produce a synergistic effect of reflectance of the first section and the second section. Further, when the relative average reflectance at a wavelength of 400 to 700 nm is less than 70%, the amount of light loss is large for reflective material, leading to low brightness in various lighting applications such as illumination and LCD backlight, which is not preferred. It is preferably 80% or more, more preferably 90%, and still more preferably 95% or more. The relative average reflectance at a wavelength of 400 to 700 nm as used herein is an average reflectance at a light wavelength of 400 nm to 700 nm, and a relative reflectance relative to a reference plate of aluminum oxide. These can be measured with a spectrophotometer using a known integrating sphere.

It is necessary that among the reflected light of the light incident upon the first section side, the reflectance of a specular reflection component be 10% or more of the relative average reflectance at a wavelength of 400 to 700 nm. This is difficult to achieve with surface reflection of a conventional white film alone and necessary from the standpoint of glossiness and brightness in various lighting designs. The reflectance of a specular reflection component is more preferably 20% or more, and still more preferably 40% or more from the standpoint of effective utilization of light leading to low power consumption, that is, low light loss. For the upper limit, if it is more than 99.9%, a mirror reflective film is provided, and the reflective film in which a diffuse reflection component and a specular reflection component are controlled is not provided. In other words, diffuse reflection does not occur at all. From this standpoint, the reflectance of a specular reflection component is more preferably 98% or less of the relative average reflectance at a wavelength of 400 to 700 nm, still more preferably 93% or less. It is preferably 40% or more because the synergistic effect of light can hardly be occurred if the percentage of the specular reflection component is too low.

The second section will be described. The second section 2 in FIG. 1(a) is a white film comprising the resin C. The white film needs to meet at least one requirement of (I) to (III) below. This is because if at least one requirement is not met, the white film has a low diffuse reflectance, not satisfying a reflection function of the reflective film 3. From the standpoint of a high diffuse reflectance, more preferably, two or more requirements are met.

(I) The voidage is 5% to 90%.

(II) The weight concentration of inorganic particles is 5% by mass to 50% by mass.

(III) The weight concentration of organic particles is 3% by mass to 45% by mass.

The voidage in the white film used as the second section is a value determined by multiplying the area ratio of a void region in the film region of the second section to the film region in the field of view obtained by observing the white film used as the second section under a cross-sectional SEM (scanning electron microscope) by 100. Therefore, there must be at least one layer that meets the requirement (I). “Void” as used herein can be formed by various forming methods and means a pore formed inside the white film.

The method of forming voids inside the white film used as the second section will now be described in detail. Examples of the method include a foam extrusion process in which a resin is impregnated with a foaming agent or carbonic acid gas to form voids in a sheet, a solvent extraction process in which one of crystalline phase and amorphous phase, and a three-dimensional network structure formed after polymer phase separation of polymer alloy or the like is dissolved with a solvent having good/poor solvent properties to form voids, and an interfacial debonding process in which a film is stretched to form voids at the interface between phases. The interfacial debonding process is preferred from the standpoint of dry process which is most convenient and low cost. The interfacial debonding process generally includes a method in which the interface between phases of two different crystal type, crystalline region and amorphous region, is cleaved and debonded by stretching, and a method in which incompatible resin particles or inorganic particles are finely dispersed in a matrix resin to form a sea-island structure; the dispersion is extruded through a T-die into a sheet by melt extrusion; the extrudate is solidified by cooling on a drum; and the solidified extrudate is stretched to debond the interface between the particles and the matrix resin to form voids. The former is a method mainly for polycrystalline polyolefins and have a low glass transition temperature, whose lamella structure has a large crystal size. One example is cleavage and debonding at the interface between α-crystal and β-crystal of polypropylene. The latter is mainly a method in which a stretchable thermoplastic resin is selected as a matrix resin, and organic particles or inorganic particles that are incompatible with the matrix resin or provide the matrix resin with high rigidity during stretching are selected, causing stress concentration at the interface between the particles and the matrix resin during stretching, whereby debonding is caused to form voids. When the voidage in the second section is less than 5%, the number of light reflections at the void interface decreases, which leads to a low reflectance. When it is 90% or more, self-supporting properties are lost, and film breakage frequently occurs during the production process. The voidage is preferably 30% to 80%, more preferably 40% to 60%.

Examples of inorganic particles that can be used in the second section include iron oxide, magnesium oxide, cerium oxide, zinc oxide, barium carbonate, barium titanate, barium chloride, barium hydroxide, barium oxide, alumina, selenite, silicon oxide (silica), calcium carbonate, titanium oxide, alumina, zirconia, aluminum silicate, mica, pearl mica, pyrophyllite clay, baked clay, bentonite, talc, kaolin, calcium phosphate, mica titanium, lithium fluoride, calcium fluoride, and other composite oxides. Titanium oxide, barium sulfate, and calcium carbonate are preferably used because a white film with a high reflectance can be obtained at low cost. When the content of inorganic particles in the second section is less than 5% by mass, the reflectance is low, and when it is 50% by mass or more, film breakage frequently occurs during the production process. Thus, it is preferably 10% by mass or more but less than 20% by mass. The content refers to a mass percentage of inorganic particles in the resin C constituting the second section. There is preferably at least one layer that meets the requirement (II).

Examples of organic particles that can be used in the second section include, but are not limited to, thermoplastic resins, thermosetting resins, and photocurable resins, and when a matrix resin (resin C) containing the particles is polyester, acrylic beads, or particles made of linear polyolefins such as polypropylene, ethylene-propylene copolymer, poly(4-methylpentene-1), and polyacetal; alicyclic polyolefins such as ring-opened metathesis polymers, addition polymers, and addition copolymers with other olefins of norbornenes; resins such as polycarbonate, polyetherimide, polyimide cross-linked polyethylene, cross-linked or non-cross-linked polystyrene resin, cross-linked or non-cross-linked acrylic resin, fluororesin, and silicone resin; and various amide compounds such as stearic acid amide, oleic acid amide, and fumaric acid amide can be used. In particular, to obtain a white film with a high reflectance, organic particles of cycloolefin copolymer such as copolymer of norbornene and ethylene, poly(4-methylpentene-1), and the like are preferred. When the content of organic particles in the second section is less than 3% by mass, the number of interfaces formed by voids is small, which leads to a low reflectance. When it is 45% by mass or more, a sea-island structure is not formed and many voids are formed, and consequently, film breakage occurs during the production process. It is preferably 10% by mass to 30% by mass.

The thickness of the second section of the reflective film is closely related to scattering frequency in optical path length of light, and therefore correlates with reflectance. Thus, to increase the reflectance, it is preferably 10 μm or more, more preferably 40 μm or more. In terms of ease of handling, the upper limit is 300 μm or less.

When two reflective films are arranged such that the surface of the first section and the second section are laminated, the rate of change in surface roughness Ra of the first section before and after relaxing treatment under the conditions of 60° C., 24 hr, and a load of 2 MPa is preferably less than 100%. Where the rate of change in surface roughness is 100% or more, irregular surface roughness of the second section is transferred to the surface of the first section, and consequently, specular reflectivity is decreased, leading to poor appearance. It is more preferably less than 50%. “Surface roughness Ra” as used herein is a center line average roughness.

The reflective film preferably comprises a transparent layer provided between the first section and the second section arranged laminatedly, the transparent layer having a thickness of 10 μm or less and a refractive index equal to or lower than the refractive index of air or of layers each forming an interface with the first section and the second section in contact with the transparent layer.

In other words, for the transparent layer, as shown in FIG. 1(b), a surface 1-1 of the first section and a surface 2-1 of the second section are opposite to each other, and air or a transparent layer 30 comprising a resin intervenes therebetween. The refractive index of the transparent layer is preferably equal to or lower than the refractive index of air or of the surface 1-1 layer of the first section and the surface 2-1 layer of the second section.

That is because a synergistic effect of reflectance is induced which provides a reflectance higher than the reflectance of each of the first section and the second section constituting the reflective film. The first section and the second section constituting the reflective film are each a biaxially stretched film obtained using mainly a polyester resin, and its refractive index after orientational crystallization is typically 1.66 (polyethylene terephthalate) and 1.79 (polyethylene naphthalate). When the refractive index of the transparent layer is higher than the refractive indices of the layers each forming an interface between the transparent layer and the first section and the second section, the transparent layer is considered to act as an optical waveguide sandwiched between the upper and lower interfaces each having a refractive index lower than the refractive index of the transparent layer. In other words, light is confined in the transparent layer, and the light 6 reflected by the second section cannot be taken out; therefore, the reflectance does not improve. The transparent layer is preferably a transparent adhesive layer, more preferably one obtained using a general-purpose resin. From this standpoint, the refractive index of the transparent layer is more preferably 1.6 or less. Too low a refractive index causes light loss, and thus it is preferably not less than 1.5. The thickness of the transparent layer present between the first section and the second section in the reflective film of the present invention is preferably 0.5 μm to 10 μm. A thickness of 10 μm or less makes it difficult to confine diffused incoherent visible light. It is more preferably 5 μm or less.

The transparent layer is preferably a transparent adhesive layer. There are transparent adhesive layers that are preferably used: adhesives in a wet or dry lamination method, and tackifiers in a hot melt or tape lamination method. The wet or dry lamination method is a method in which water-based or solvent-based adhesive is applied, for example, by reverse coating, gravure coating, rod coating, bar coating, meyer bar coating, die coating, spray coating, or the like when a film of the first section and a film of the second section are laminated. Examples of adhesives include thermosetting adhesives such as phenolic resin adhesive, resorcinol resin adhesive, phenol-resorcinol resin adhesive, epoxy resin adhesive, urea resin adhesive, urethane resin adhesive, polyurethane resin adhesive, polyester urethane resin adhesive, polyaromatic adhesive, and polyester adhesive; reactive adhesives obtained using ethylene-unsaturated carboxylic acid copolymer or the like; thermoplastic adhesives such as vinyl acetate resin, acrylic resin, ethylene vinyl acetate resin, polyvinyl alcohol, polyvinyl acetal, polyvinyl butyral, vinyl chloride resin, nylon, and cyanoacrylate resin; rubber adhesives such as chloroprene adhesive, nitrile rubber adhesive, SBR adhesive, and natural rubber adhesive; and photocurable adhesives obtained using methacrylate resin, photocurable polychlorobiphenyl, alicyclic epoxy resin, photocationic polymerization initiators, acrylate resin (containing SI, F), photoradical polymerization initiators, fluorinated polyimide, or the like. These resins may be made of a single polymer or may be a mixture. The transparent adhesive layer used in the present invention is preferably a polyester resin adhesive in terms of heat resistance and conformability in molding. Examples of polyester resins include saturated polyester resin, unsaturated polyester resin, and alkyd resin. The polyester resin is preferably used in combination with bisphenol A, phenol novolac epoxy resin, or the like. Their mixing ratio is preferably polyester resin/epoxy resin (weight ratio)=50/50 to 90/10. The use at such a mixing ratio, as compared to the use of polyester resin alone, provides a high adhesive strength.

The tape lamination method is a method in which a tackifier on a film or a sheet substrate is directly laminated to a laminated film used as the first section or a white film used as the second section. After the lamination, the core substrate will be peeled and removed. Examples of tackifiers include acrylic tackifiers, rubber tackifiers, polyalkyl silicone tackifiers, urethane tackifiers, and polyester tackifiers. The hot melt method is a method in which a thermoplastic resin tackifier is melted by heat for adhesion. Examples of thermoplastic resins include vinyl acetate resin, acrylic resin, ethylene vinyl acetate resin copolymer, polyvinyl alcohol copolymer, polyvinyl acetal, polyvinyl butyral, vinyl chloride resin, nylon, cyanoacrylate resin, polyester resin, and mixtures and copolymers thereof. Among them, ethylene vinyl acetate copolymer and polyvinyl butyral which are easily bonded by thermocompression are preferred. For adhesion in the hot melt method, extrusion lamination, film insert molding, and the like can be used.

As a cross-linking agent used in the transparent adhesive layer, for example, when an acrylic resin comprising a hydroxyl group or a carboxyl group is used, a polyepoxide compound or a polyisocyanate compound is preferably used. Examples of polyepoxide compounds include sorbitol polyglycidyl ether, polyglycerol polyglycidyl ether, pentaerythritol polyglycidyl ether, diglycerol polyglycidyl ether, triglycidyl-tris(2-hydroxyethyl) isocyanurate, glycerol polyglycidyl ether, trimethylolpropane polyglycidyl ether, resorcin glycidyl ether, neopentyl glycol diglycidyl ether, 1,6-hexanediol diglycidyl ether, bisphenol-5-diglycidyl ether, ethylene glycol diglycidyl ether, polyethylene glycol diglycidyl ether, and propylene glycol diglycidyl ether. Examples of polyisocyanate compounds include tolylene diisocyanate, 2,4-tolylene diisocyanate dimer, naphthylene-1,5-diisocyanate, o-tolylene diisocyanate, diphenylmethane diisocyanate, triphenylmethane triisocyanate, tris-(pisocyanatophenyl)thiophosphite, polymethylene polyphenyl isocyanate, hexamethylene diisocyanate, trimethylhexanemethylene diisocyanate, isophorone diisocyanate, and trimethylhexamethylene diisocyanate. In addition, melamine cross-linking agents, isocyanate cross-linking agents, aziridine cross-linking agents, epoxy cross-linking agents, methylolated or alkylolated urea resins, acrylamide resins, polyamide resins, various silane coupling agents, various titanate coupling agents, and the like can be used.

Preferred cross-linking agents including a polyester resin and epoxy resin as a base resin are aromatic isocyanates and aliphatic isocyanates. The amount of isocyanate is preferably 5 to 15 parts by weight based on 100 parts by weight of the total amount of the polyester resin and epoxy resin.

In the tape lamination method, the thickness of the transparent adhesive layer is preferably 1 to 200 μm because as the thickness increases, surface irregularities of the second section become less likely to be transferred to the surface of the first section. It is more preferably 3 to 50 μm because if the adhesive layer is too thick, defects such as burrs tend to occur after lamination, and if it is too thin, transfer tends to occur due to particle projection.

To the transparent adhesive layer, various additives may be added, such as viscosity modifiers, plasticizers, leveling agents, anti-gelling agents, antioxidants, heat stabilizers, light stabilizers, UV absorbers, lubricants, pigments, dyes, organic or inorganic fine particles, fillers, antistatic agents, nucleating agents, and curing agents.

Further, it is preferred that a hard coat layer be formed on one surface of the first section. This is because by forming a hard coat layer, surface irregularities of the second section become less likely to be transferred to the surface of the first section. More preferably, hard coat layers are provided on both surfaces.

For a hard coat layer, ceramics and photocurable and thermosetting resins are preferably used. For the former, if it is too thick, cracking during molding and the like occurs, and thus it is preferably 0.05 to 10 μm, more preferably 2 to 7 μm. Preferred ceramics are transparent metal oxide and transparent nonmetal oxide, and in particular, alumina and SiO₂ are preferred from the standpoint of low cost. They can be formed, for example, by a deposition technique such as sputtering.

For the curable resin, for example, photocurable resins such as methacrylate resin, photocurable polychlorobiphenyl, alicyclic epoxy resin, photocationic polymerization initiators, acrylate resin (containing SI, F), photoradical polymerization initiators, and fluorinated polyimide can be used. The thermosetting resin may be any resin containing a cross-linking agent, such as epoxy, phenolic, urethane, acrylic, polyester, polysilane, or polysiloxane resin. The resin constituting the film may be made of a single polymer or may be a mixture.

Preferred resins for forming a hard coat layer need to be less likely to curl and have a high adhesion with a substrate, and examples thereof include low-shrinkage urethane acrylates and epoxy compounds. Specific examples of urethane acrylates include AT-600, UA-1011, UF-8001, UF-8003, etc. available from KYOEISHA CHEMICAL Co., LTD.; UV7550B, UV-7600B, etc. available from Nippon Synthetic Chemical Industry Co., Ltd.; U-2PPA, UA-NDP, etc. available from SHIN-NAKAMURA CHEMICAL CO., LTD.; and Ebecryl-270, Ebecryl-284, Ebecryl-264, Ebecryl-9260, etc. available from Daicel UCB Co., Ltd. Specific examples of epoxy compounds include EHPE3150, GT300, GT400, CELLOXIDE 2021, etc. available from Daicel Chemical Industries, Ltd.; and EX-321, EX-411, EX-622, etc. available from Nagase ChemteX Corporation. However, these are non-limiting examples. Among the urethane acrylates that can achieve a higher hardness, urethane acrylate oligomer and monomer can be obtained by reacting a polyhydric alcohol, a polyhydric isocyanate, and a hydroxyl-containing acrylate. Specific examples thereof include UA-306H, UA-306T, UA-3061, etc. available from KYOEISHA CHEMICAL Co., LTD.; UV-1700B, UV-6300B, UV-7600B, UV-7605B, UV-7640B, UV-7650B, etc. available from Nippon Synthetic Chemical Industry Co., Ltd.; U-4HA, U-6HA, UA-100H, U-6LPA, U-15HA, UA-32P, U-324A, etc. available from SHIN-NAKAMURA CHEMICAL CO., LTD.; Ebecryl-1290, Ebecryl-1290K, Ebecryl-5129, etc. available from Daicel UCB Co., Ltd.; and UN-3220HA, UN-3220HB, UN-3220HC, UN-3220HS, etc. available from Negami Chemical Industrial Co., Ltd., but are not limited thereto.

The radically polymerizable compounds and cationically polymerizable compounds described above may be used alone or in combination of two or more thereof.

When a resin that is cross-linked by UV irradiation is used, acetophenones, benzophenones, α-hydroxy ketones, benzyl methyl ketals, α-amino ketones, bisacylphosphine oxides, and the like are used alone or in combination as a photoradical polymerization initiator. Specific examples thereof include Irgacure 184, Irgacure 651, Darocure 1173, Irgacure 907, Irgacure 369, Irgacure 819, Darocure TPO, etc. available from Ciba Specialty Chemicals K. K. The photocationic polymerization initiator may be any initiator that generates a cation polymerization catalyst such as Lewis acid upon UV irradiation. For example, onium salts such as diazonium salt, iodonium salt, and sulfonium salt can be used. Specific examples thereof include aryldiazonium hexafluoroantimonate, aryldiazonium hexafluorophosphate, aryldiazonium tetrafluoroborate, diaryliodonium hexafluoroantimonate, diaryliodonium hexafluorophosphate, diaryliodonium tetrafluoroborate, triarylsulfonium hexafluoroantimonate, triarylsulfonium hexafluorophosphate, and triarylsulfonium tetrafluoroborate. These may be used alone or in combination of two or more thereof.

Photocationic polymerization initiators that may be used are, specifically, commercially available photocationic initiators. Examples thereof include UVI-6990 available from Union Carbide Corporation, UVI-6992 available from Dow Chemical Japan Ltd., Uvacure 1591 available from Daicel UCB Co., Ltd., ADEKA OPTOMER SP-150 and ADEKA OPTOMER SP-170 available from Asahi Denka Kogyo K.K., DPI-101, DPI-105, MPI-103, MPI-105, BBI-101, BBI-103, BBI-105, TPS-102, TPS-103, TPS-105, MDS-103, MDS-105, DTS-102, and DTS-103 available from Midori Kagaku Co., Ltd., Irgacure 250 available from Ciba Specialty Chemicals K. K., etc.

For the hard coat layer, isocyanates having two or more isocyanate groups in its molecule are preferably used. For example, diisocyanates such as hexamethylene diisocyanate, diphenylmethane diisocyanate, xylylene diisocyanate, isophorone diisocyanate, phenylene diisocyanate, tolylene diisocyanate, trimethylhexamethylene diisocyanate, naphthalene diisocyanate, diphenyl ether diisocyanate, diphenylpropane diisocyanate, biphenyl diisocyanate, and isomers, alkyl-substituted products, halides, and benzene hydrogenated products thereof can be used. Further, triisocyanates having three isocyanate groups, tetraisocyanates having four isocyanate groups, and the like can also be used, and these can be used in combination. Among them, aromatic polyisocyanates are preferred from the standpoint of heat resistance, and aliphatic polyisocyanates or alicyclic polyisocyanates are preferred from the standpoint of color protection. Examples of commercially available isocyanate prepolymers include Desmodur E3265, E4280, TPLS2010/1, E1160, E1240, E1361, E14, E15, E25, E2680, Sumidur E41, E22 available from Sumika Bayer Urethane Co., Ltd., Duranate D-101, D-201 available from Asahi Chemical Industry Co., Ltd., etc.

Blocked isocyanate can also be used. Blocked compound is a compound formed by the reaction of a given compound with a blocking agent and temporarily inactivated by a group derived from the blocking agent, and upon heating at a given temperature, the group derived from the blocking agent dissociates to form an active group. In blocked isocyanate, an isocyanate group of the unblocked polyisocyanate compound is blocked with a blocking agent, and examples of the blocking agent include phenol-based blocking agents such as phenol, cresol, and xylenol; lactam-based blocking agents such as ε-caprolactam, δ-valerolactam, γ-butyrolactam, and β-propiolactam; alcohol-based blocking agents such as methanol, ethanol, n-propyl alcohol, isopropyl alcohol, n-butyl alcohol, isobutyl alcohol, tert-butyl alcohol, ethylene glycol monoethyl ether, ethylene glycol monobutyl ether, diethylene glycol monoethyl ether, propylene glycol monomethyl ether, and benzyl alcohol; oxime-based blocking agents such as formamidoxime, acetaldoxime, acetoxime, methyl ethyl ketoxime, diacetyl monoxime, benzophenone oxime, and cyclohexane oxime; and active methylene-based blocking agents such as dimethyl malonate, diethyl malonate, ethyl acetoacetate, methyl acetoacetate, and acetylacetone. Among them, phenol-based blocking agents are suitably used.

Examples of phenols include monofunctional phenols such as phenol, cresol, xylenol, trimethylphenol, butylphenol, phenylphenol, and naphthol; bifunctional phenols such as hydroquinone, resorcinol, catechol, bisphenol A, bisphenol F, biphenol, naphthalenediol, dihydroxydiphenyl ether, and dihydroxydiphenyl sulfone, and isomers and halides thereof; and polyfunctional phenols such as pyrogallol, hydroxyhydroquinone, phloroglucin, phenol novolac, cresol novolac, bisphenol A novolac, naphthol novolac, and resol.

The blocking agent is preferably used such that active hydrogen in the blocking agent is 0.5 to 3.0 equivalents for 1.0 equivalent of isocyanate group in isocyanate. If it is less than 0.5 equivalents, blocking is incomplete, and a high-molecular-weight epoxy polymer is highly likely to gelate. When it is more than 3.0 equivalents, the blocking agent is redundant, and the blocking agent may remain on a film formed to reduce heat resistance and chemical resistance.

The blocked isocyanate compound may be commercially available one, and examples thereof include Sumidur BL-3175, BL-4165, BL-1100, BL-1265, BL-3272, Desmodur TPLS-2957, TPLS-2062, TPLS-2957, TPLS-2078, TPLS-2117, Desmotherm 2170, Desmotherm 2265 (trade name, available from Sumitomo Bayer Urethane Co., Ltd.); CORONATE 2512, CORONATE 2513, CORONATE 2520 (trade name, available from NIPPON POLYURETHANE INDUSTRY CO., LTD.); B-830, B-815, B-846, B-870, B-874, B-882 (trade name, available from Mitsui Takeda Chemicals Inc.), etc. Sumidur BL-3175 and BL-4265 are obtained using methylethyl oxime as a blocking agent, and Sumidur BL-3272 is obtained using ε-caprolactam as a blocking agent.

The dissociation temperature of the group derived from the blocking agent in the blocked isocyanate compound is preferably 120 to 200° C. from the standpoint of influence on a constituent material of electronic parts obtained using a photosensitive resin composition, production environment, process conditions, material storage temperature, and the like.

For the amount of isocyanate relative to that of acrylate, polyester polyol, and epoxy polymer, the isocyanate equivalent is preferably in the range of 0.1 to 2 for 1 equivalent of alcoholic hydroxyl group. When it is less than 0.1, cross-linking is less likely to occur, and when it is more than 2, the isocyanate may remain in a film to reduce heat resistance and chemical resistance.

Examples of suitable organic solvents used for application of the transparent adhesive layer and the hard coat layer of the present invention include methyl acetate, ethyl acetate, propyl acetate, butyl acetate, xylene, methyl ethyl ketone, methyl isobutyl ketone, ethylene glycol monoethyl ether acetate, and propylene glycol monomethyl ether acetate, and several of them may be used in combination. These solvents can be present in the composition in an amount up to 95% by weight of the whole composition. These solvents are substantially removed when a solution is applied to the transparent substrate described above and dried. Further, monofunctional monomers such as 2-hydroxyethyl(meth)acrylate, 2-hydroxypropyl(meth)acrylate, and glycidyl(meth)acrylate, preferably, in an amount of 10% by weight or less based on the solid content can be used as a diluent. Examples of cationically polymerizable diluents include CELLOXIDE 3000, CELLOXIDE 2000, etc available from Daicel Chemical Industries, Ltd.

A wavelength range where the reflectance of light incident upon the surface at the first section side is higher than the reflectance of light incident upon the surface at the second section side preferably exists in the visible-light region. When the reflectance of light incident upon the surface at the first section side is lower than the reflectance of light incident upon the surface at the second section side, it means that a synergistic effect of light reflection due to combination of functions of the first section, a specular reflector, and the second section, a diffuse reflector, is not provided. The synergistic effect of light reflection means that the reflectance of the reflective film (R) is higher than the reflectance of the first section alone (R1) and the reflectance of the second section alone (R2). The theory of the synergistic effect of reflectance will now be described. When multiple reflection is not taken into account, if the intensity of light is 1, then a theoretical reflectance is determined according to the following equation (1) or equation (2).

R=R1+(1−R1)·R2 (1)

R=R2+(1−R2)·R1 (2)

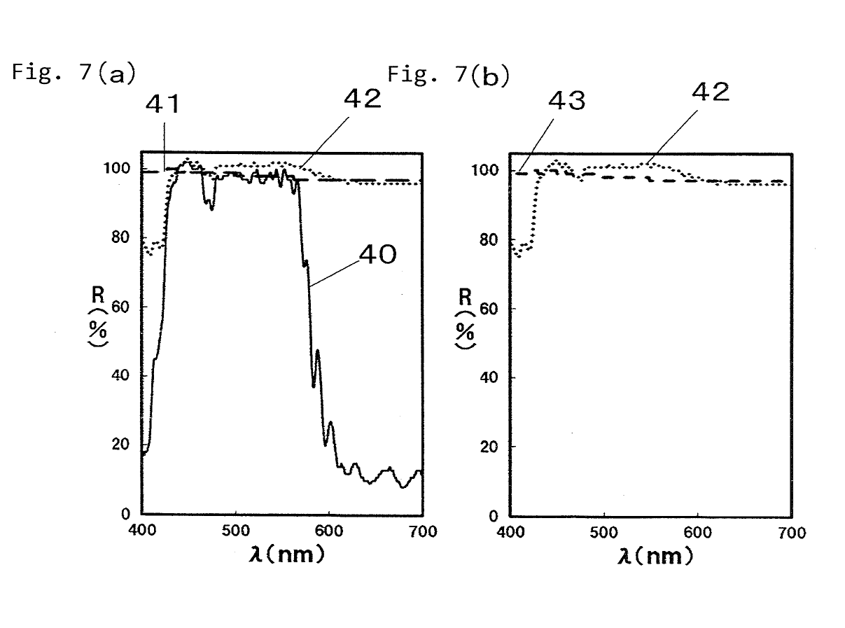

In other words, the synergistic effect of reflectance means that the second term on the right side of the equation (1) or (2) indicates a positive value. Further, the synergistic effect of light will be described using a spectral reflectance curve. Description will be given in detail with reference to the synergistic effect of reflectance in Example 9. FIG. 7(a) shows a spectral reflectance curve 40 of the first section constituting the reflective film of Example 9, a spectral reflectance curve 41 of the second section, and a spectral reflectance curve 42 of Example 9 obtained when light is incident upon the first section side. In the reflective film of Example 9, the synergistic effect of reflectance can be observed in or near the wavelength range of 450 to 550 nm where the reflectance of the first section alone is high.

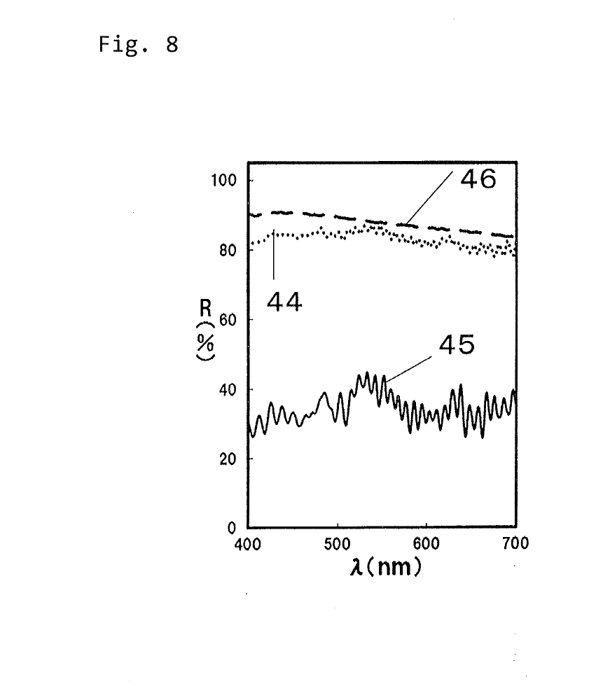

FIG. 7(b) shows the spectral reflectance curve 42 obtained when light is incident upon the first section side of the reflective film of Example 9 and a spectral reflectance curve 43 obtained when light is incident upon the second section side. When light is incident upon the surface at the second section side, a spectral reflectance curve 43 similar to the reflectance curve 41 of the second section alone is obtained, and the synergistic effect of reflectance is not observed throughout the wavelength range. On the other hand, when light is incident upon the first section side, it can be seen that the reflectance in the visible-light region at a wavelength of 450 to 550 nm has improved as compared to when light is incident upon the second section side. On the other hand, as an example of the case where the synergistic effect of reflectance is not produced, a spectral reflectance curve 44 of the reflective film of Comparative Example 3, a spectral reflectance curve 45 of the first section alone, and a spectral reflectance curve 46 of the second section alone are shown in FIG. 8. It can be seen that the reflectance of the reflective film is lower than the reflectance of the white film used as the second section constituting the reflective film.

Further, the surface roughness of the first section and the surface roughness of the second section at the interface arranged laminatedly are preferably 20 nm or less and 35 nm or less, respectively. The surface roughness of the first section at the interface arranged laminatedly being 20 nm or less means that the surface roughness of the surface 1-1 opposite to the second section shown in FIG. 1(b) is 20 nm or less. A surface roughness of 20 nm or less can be considered to be plane, and does not contribute to diffusion of light. It is more preferably 10 nm or less. The surface roughness of the second section is preferably 35 nm or less. The surface roughness of the second section at the interface arranged laminatedly refers to the surface roughness of the surface 2-1 in FIG. 1(b). If the surface roughness is 35 nm or less, when light transmitted through the laminated film used as the first section reflects in the interior and at the interface with the white film used as the second section, the light can be taken out of the first section efficiently. As a result, the synergistic effect of reflectance of the first section and the second section is produced. If the interface is rough, reflected light at the second section penetrates into the first section at a very wide angle, which enhances the light returning effect due to reflection in the first section, and consequently, light returns to a transparent adhesive layer 30 and the second section, which increases light leakage at the end face of the reflective film and light loss due to the interior light absorption, resulting in unimproved reflectance.

“Surface roughness” as used herein is a center line average roughness. The method of achievement is to use a laminated film of at least two-layer structure as the second section, the film containing substantially no inorganic and organic particles on the outer layer side. When contribution as a slippery layer is required, it is preferable to minimize the amount of inorganic particles, and the particle concentration is preferably 0.1% by mass or less based on the total mass of the layer. It is more preferably 0.05% by mass or less. The most preferred method of achievement is to not add particles as the lubricant into the resin of an outermost layer and to provide slipperiness using a coating containing a small amount of particles. When the surface roughness is 10 nm or less, the surface is almost an ideal plane, which is preferred.

Further, also another surface 2-2 of the second section shown in FIG. 1(b) is preferably plane. This is a surface that comes into contact with a laminated film surface 1-2 of the first section when the reflective film is wound into a roll. When the surface roughness of the surface 2-2 of the second section which is a white film is 35 nm or less, the surface is substantially plane. Consequently, irregularities are hardly transferred to the surface 1-2 of the first section, and a reflective film with high glossiness and no defect in appearance can be obtained. It is more preferably 22 nm or less.

To ensure the planeness of both surfaces of the second section, the second section of the reflective film preferably has a three-layer structure in which the inner layer is a diffuse reflection layer. Specifically, it takes (a)/(b)/(a) or (a)/(b)/(c) three-layer laminated structure, wherein the layer (b) is a diffuse reflection layer. By taking such a laminated structure, outer layers, the layer (a) or the layer (c), can be freely designed independently of the diffuse reflection layer, the layer (b). The layers (a) and (c) are preferably slippery layers. From the standpoint, for example, of cost, the (a)/(b)/(a) three-layer structure is preferred. The layer (a) or (c) may be a coating layer because a slippery surface is preferred. To achieve both planeness and slipperiness, the thickness of the layer (a) or (c) is preferably 0.1 to 10 μm.

In general, the laminated film used as the first section is soft because it is a film including 200 or more laminated layers each having a nano-level thickness, and thus surface irregularities of the white film used as the second section tend to transfer to the laminated film. Thus, the thickness of the outermost layer of the first section of the reflective film is preferably 5 μm or more. If the outer layer thickness is less than 5 μm, disturbed lamination tends to occur, which is accompanied by poor appearance. In addition, the first section has low stiffness, which is one of the mechanical properties, and is flexible, and therefore surface irregularities of the second section tend to transfer thereto. It is more preferably 7 μm or more, still more preferably 10 μm to 30 μm.

The resin A or the resin B of the first section of the reflective film is preferably decalin acid copolyester. When polyethylene terephthalate or polyethylene naphthalate which will be orientationally crystallized is used as a main chain backbone of the resin A or the resin B, the decalin acid component is preferably copolymerized as a carboxylic acid component in an amount of 2 mol % to 50 mol % in order to decrease the refractive index while reducing the decrease in glass transition temperature. In particular, decalin acid co-polyethylene naphthalate is preferred because it leads to improvement in moldability.

In the reflective film, the reflectance in the first section is preferably higher than the reflectance in the second section. The reflectance in the first section is a relative reflectance in the laminated film used as the first section alone in a wavelength range of 400- to 700-nm reflection band, and there is preferably a reflection wavelength at which this relative reflectance is higher than the relative reflectance in the white film used as the second section alone. When the reflectance in the white film used as the second section is significantly higher, the ratio of the diffuse reflection component in the total incident energy of light increases, and a light returning effect is strongly acted, thus failing to produce a synergistic effect of optical interference reflection and diffuse reflection. For the relative average reflectance at a given wavelength or a wavelength of 400 to 700 nm, when the difference in relative reflectance between the first section alone and the second section alone is 30% or more, a significant light returning effect predominates.

The reflective film preferably has a lightness L* (SCE) of 22 to 70. Here, SCE refers to a mode of measurement of the lightness of reflected light. A method in which a light trap is provided on the detector side and color is measured with specularly reflected light removed is called SCE (specular component excluded) mode, and a method in which a light trap is not provided and color is measured without removing specularly reflected light is called SCI (specular component included) mode. In other words, lightness L* (SCE) represents a haze level of reflected light. When the lightness L* (SCE) is less than 22, the reflective film is almost a mirror and not a film having both diffusibility and specular reflectivity. On the other hand, when the lightness L* (SCE) is more than 70, diffuse reflected light is overwhelmingly dominant over specularly reflected light, and the surface of the laminated film looks whitish. More preferably, the lightness L* (SCE) is 30 to 60.

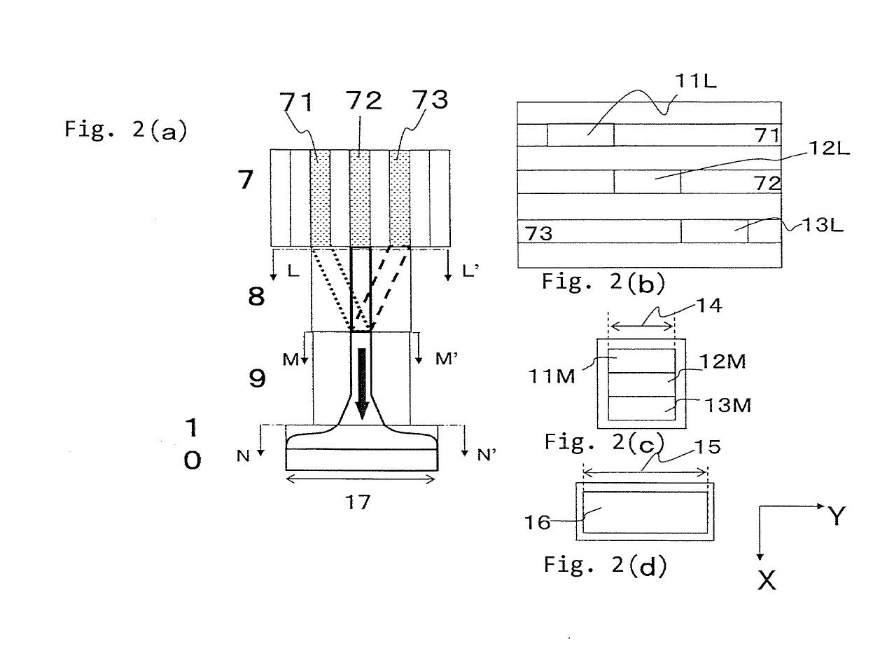

A process of producing the laminated film used as the first section in the reflective film will be described. A process of producing a laminated structure will be described below specifically with reference to FIG. 2.

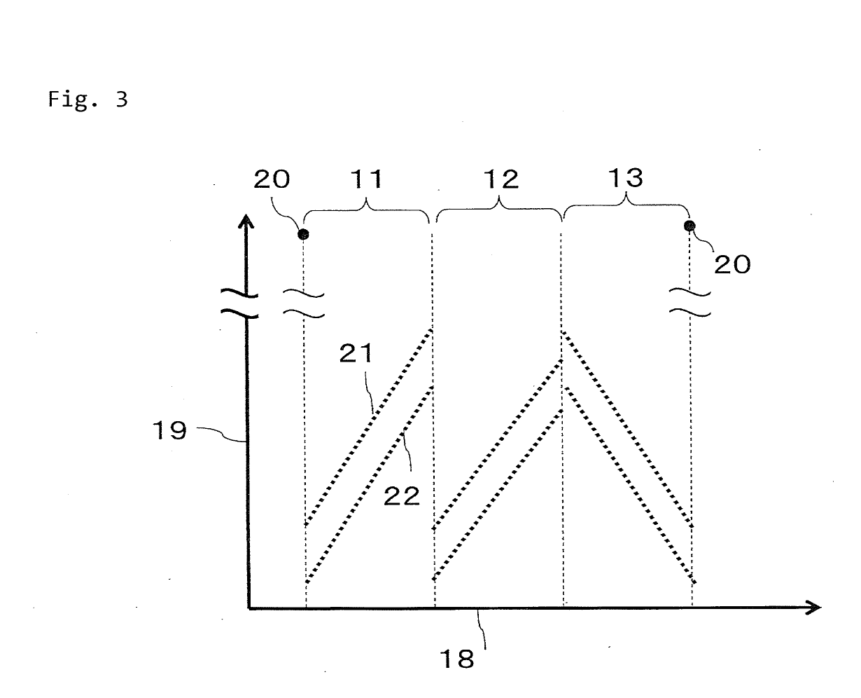

A laminating apparatus 7 shown in FIG. 2 has three slit plates. An example of the layer thickness distribution of a laminated structure produced using the laminating apparatus 7 is shown in FIG. 3. When a layer sequence 18 is taken along the abscissa, and a layer thickness (nm) 19 along the ordinate, the laminated structure has three slant structures: an slant structure 11 of layer thickness due to a laminated flow of resins formed by a slit plate 71 shown in FIG. 2, an slant structure 12 of layer thickness due to a laminated flow of resins formed by a slit plate 72 shown in FIG. 2, and an slant structure 13 of layer thickness due to a laminated flow of resins formed by a slit plate 73 shown in FIG. 2. As shown in FIG. 3, one slant structure is preferably opposite to any other slant structure. Further, to prevent flow marks caused by an instability phenomenon of resin flow, a thick-film layer 20 with a thickness of 1 μm or more is provided at the outermost layer. The slant structure formed by one slit plate has a layer thickness distribution 21 of a thermoplastic resin A and a layer thickness distribution 22 of a thermoplastic resin B, and its lamination ratio can be readily controlled by the ratio of extrusion rates of the thermoplastic resin A and the thermoplastic resin B from two extruders. From the standpoint of high reflectance and high moldability, the lamination ratio is preferably 0.5 to 2.5. For the range of the layer thickness in each slant structure, to strongly reflect light over the whole visible-light region, a film is formed in such a manner that the thickness of the laminated film is adjusted such that the average layer thickness is 60 nm to 170 nm.

Resin flows with a laminated structure flown out of the slit plates constituting the laminating apparatus 7 are flown out of outlets 11L, 12L, and 13L of the laminating apparatus as shown in FIG. 2(b), and then at a combiner 8, rearranged in a cross-sectional shape of 11M, 12M, and 13M shown in FIG. 2(c). In a connecting pipe 9, the rearranged resin flow is then flown into a die 7 with the length of a flow path cross-section in the film width direction being widened, further widened at a manifold, extruded in a molten state through a lip of a die 10 into a sheet, and solidified by cooling on a casting drum to obtain an unstretched film. Here, when a ratio of widening in the die, which is a value obtained by dividing a length of the die lip in the film width direction 17 by a length in the film width direction at an inlet of the die 15, is 5 or less, a reflector that is a laminated film having a uniform reflectance and reflection band in the film width direction can be obtained. More preferably, the ratio of widening is 3 or less. Subsequently, the unstretched film obtained may be stretched as required at a temperature equal to or higher than the glass transition point temperature (Tg) of the constituent resins. For a stretching method in this case, it is preferable to employ a known biaxial stretching method such as sequential biaxial stretching or simultaneous biaxial stretching in order to achieve high reflectance, thermal dimensional stability, and larger area. For the known biaxial stretching method, a method in which a film is stretched in the longitudinal direction and then stretched in the width direction or a method in which a film is stretched in the width direction and then stretched in the longitudinal direction may be used, or stretching in the longitudinal direction and stretching in the width direction may be carried out for several times in combination. For example, in the case of a stretched film comprising polyester, a stretching temperature and a stretching magnification can be selected as appropriate, but in the case of a conventional polyester film, the stretching temperature is preferably 80° C. to 150° C., and the stretching magnification is preferably 2-fold to 7-fold. The resin A layer is orientationally crystallized by sequential biaxial stretching, and to induce the increase in in-plane refractive index of the A layer to increase the reflectance, the stretching temperature is preferably 90° C. or higher. The stretching in the longitudinal direction is carried out utilizing the change in peripheral speed between rolls. For the stretching in the width direction, a known tenter method is used. That is, a film is conveyed with both ends held by clips and stretched in the width direction. In the simultaneous biaxial stretching, a film is conveyed with both ends held by clips with a simultaneous biaxial tenter, and stretched in the longitudinal direction and the width direction simultaneously and/or sequentially. The stretching in the longitudinal direction can be achieved by increasing the distance between the clips of the tenter, and the stretching in the width direction by increasing the distance between rails on which the clips travel. The tenter clip for stretching/heat treatment in the present invention is preferably driven by a linear motor. It can also be driven by a pantograph or a screw, but the linear motor is advantageous in that the stretching magnification can be freely changed because the degree of freedom of each clip is high. In the case a conventional polyester film, conditions such as stretching magnification, stretching temperature, and heat treatment temperature are similar to those in sequential biaxial stretching.

To maintain and keep present the orientation in the resin A occurred in the stretching process and relax the orientation of the resin B in order to increase the specular reflectance, heat treatment is preferably performed at 210° C. to 230° C. To impart thermal dimensional stability to the film, it is also preferable to perform relaxation heat treatment of about 2 to 10% in the width direction or the longitudinal direction.

Next, a process of producing the white film used as the second section in the reflective film will be described. Construction of the white film is not critical and may be selected as appropriate depending on the application and required properties, and preferred is a monolayer and/or two or more layer composite film having a construction of at least one or more layers, the composite film containing any one or more of voids, inorganic particles, and organic particles in the at least one or more layers. A preferred construction is a three-layer structure.

Next, a white film produced by the interfacial debonding process, one of the methods of producing a white film, will be described. A method of producing a white film (polyester film) of particularly preferred three-layer construction will be described, but this is not a limiting example. First, a master pellet containing particles such as inorganic particles or organic particles and a master pellet of polyethylene terephthalate used as a matrix resin are provided. They are dried, melt-kneaded in a twin-screw extruder (L/D=42) at 270 to 300° C., and fed to a layer (b) that serves as a diffuse reflection layer in a three-layer pinole (a)/(b)/(a) structure.

When inorganic particles are used, a master pellet of polyethylene terephthalate containing titanium oxide, barium sulfate, and calcium carbonate as inorganic particles is provided. When organic particles are used, norbornene-based cycloolefin copolymer is provided as an incompatible resin, and a master pellet of polyethylene glycol, polybutylene terephthalate/polytetramethylene glycol copolymer, and polyethylene terephthalate copolymer comprising 30 mol % of cyclohexanedimethanol is provided as a compatibilizer.

Meanwhile, polyethylene terephthalate containing inorganic and/or organic particles as the lubricant is kneaded in a known single-screw extruder and fed to layers (a) that serve as slippery layers in the three-layer pinole (a)/(b)/(a) structure. Subsequently, (a)/(b)/(a) three-layer structure is formed in the pinole, guided to a T-die, and discharged through a die lip into a sheet. This three-layer laminated sheet in a molten state is brought into close contact with a casting drum by electrostatic application, and solidified by cooling to obtain an unstretched film. The unstretched film is guided to a group of rolls heated to 80 to 120° C., and stretched 2.0- to 5.0-fold in the longitudinal direction. The film is then guided to a tenter with both ends held by clips, and stretched 3.0- to 5.0-fold in the transverse direction in an atmosphere heated to 90 to 140° C. Further, to impart planarity and dimensional stability to the biaxially stretched film, the film is heat-set in the tenter at 150 to 230° C., and slowly cooled uniformly. Furthermore, after cooling to room temperature, the film is wound up with a winder to obtain a white film used as the second section of the reflective film.

Next, examples of various known white films that can be used as the second section will be listed. Examples of white films of monolayer construction include Lumirror (registered trademark) E20 (available from TORAY INDUSTRIES, INC.), SY64, SY70 (available from SKC), and White Refstar (registered trademark) WS-220 (available from Mitsui Chemicals, Inc.); examples of white films of two-layer construction include Tetoron (registered trademark) film UXZ1, UXSP (available from Teijin DuPont Films Japan Limited), and PLP230 (available from Mitsubishi Plastics, Inc.); and examples of white films of three-layer construction include Lumirror (registered trademark) E60L, E6SL, E6SR, E6SQ, E6Z, E80, E80A, E80B (available from TORAY INDUSTRIES, INC.), and Tetoron (registered trademark) film UX, UXH (available from Teijin DuPont Films Japan Limited). Examples of white sheets of other constructions include Optilon ACR3000, ACR3020 (available from DuPont), and MCPET (registered trademark) (available from FURUKAWA ELECTRIC CO., LTD.), but are not limited thereto.

The method of producing the reflective film is preferably a melt extrusion method using coextrusion, which is a method of producing a reflective film using a feed block to form the first section and a combiner for combining the second section with the first section. In other words, the reflective film may be produced by laminating the laminated film and the white film by postprocessing, but from the standpoint of productivity and impartment of planeness to the interface between the first section and the second section, it is preferably produced by co-molding by coextrusion. In performing co-molding, two extruders for each of the resin A and the resin B of the laminated film and one extruder for the resin C of the white film are necessary. In a two-layer pinole, the resin to form the laminated film flows through the first layer, and the resin to form the white film flows through the second layer, whereby the resins can be formed into a sheet by the known method described above, and the sheet can also be formed into a film by sequential biaxial stretching.

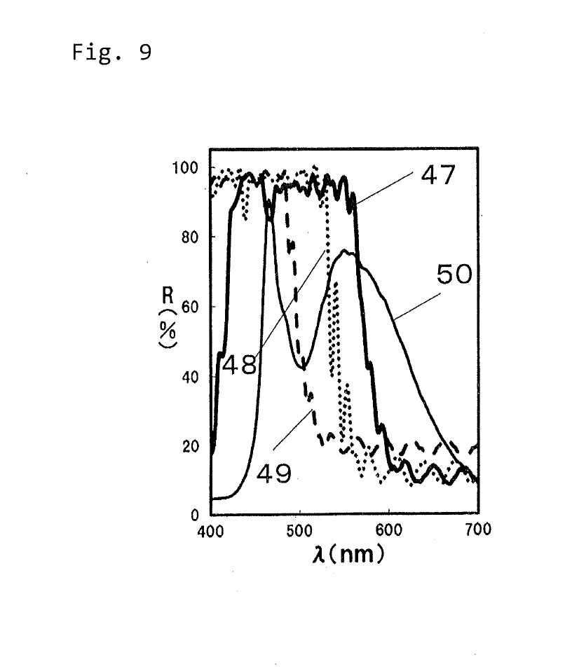

The reflective film preferably has an absolute reflectance of 95% or more in a wavelength range of either 450 nm±30 nm or 550 nm±30 nm under conditions of a light incidence angle of 30° or more but less than 90°. The absolute reflectance is an absolute reflectance in a light incidence angle range of 30° or more but less than 90°, and can be measured using an angle-adjustable absolute reflectance apparatus. For the absolute reflectance, a maximum reflectance in a wavelength range of either 450 nm±30 nm or 550 nm±30 nm is employed. The properties of the reflective film with respect to light incidence angle will be described using measurement results of angle-adjustable absolute reflectance of the laminated film used as the first section constituting the reflective film of Example 9. FIG. 9 shows an absolute reflectance curve 47 at a light incidence angle of 20° (solid line), an absolute reflectance curve 48 at 40° (dotted line), and an absolute reflectance curve 49 at 60° (dashed line) of the laminated film alone constituting the reflective film of Example 9, and an intensity distribution 50 of general white LED illumination light. As can be seen, the wavelength shifts and the reflectance increases depending on the incidence angle. The reflective film of Example 9 retains a reflection band at a wavelength of 450±30 nm. At 450 nm, a center emission wavelength of blue of a white light source LED, the reflective film of Example 9 has a higher reflectance at every angle of light incidence.

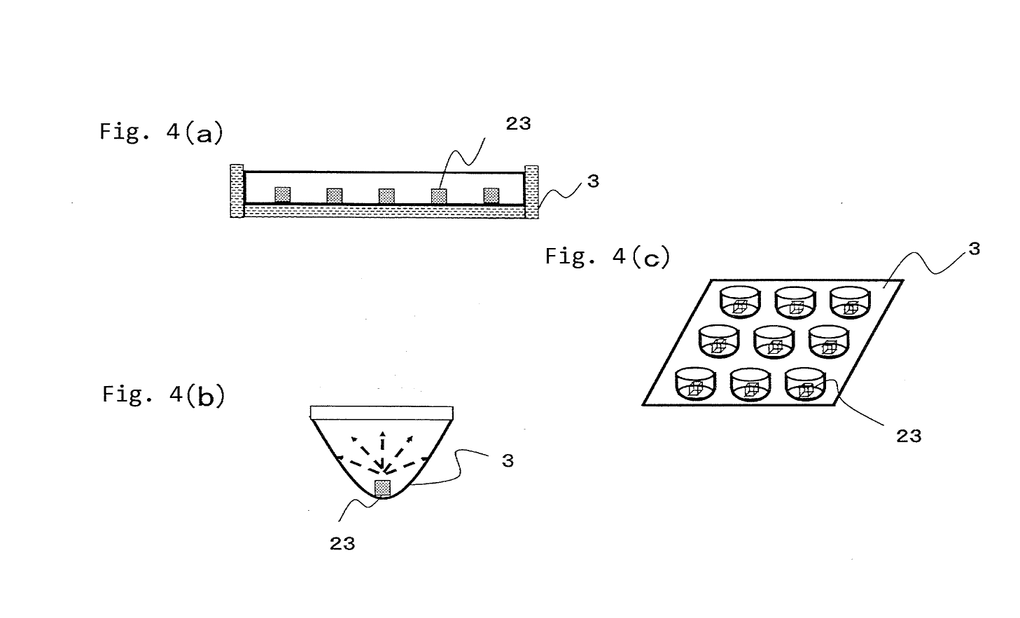

Examples of lighting systems including the reflective film are shown in FIG. 4. FIG. 4(a) is a box-type lighting system in which LED light sources 23 are disposed on a plane and surrounded by the reflective film 3 of the present invention. A transparent diffuser sheet may be disposed at the side of light irradiation. FIG. 4(b) is a lighting system designed such that the reflective film 3 has a parabolic shape so that light from an LED light source 23 can be taken out efficiently. FIG. 4(c) is a molded product of the reflective film 3 molded such that a plurality of LED light sources 23 can be placed, and as in the case of FIG. 4(b), light from LED light sources 23 can be taken out of cavities, which are regularly arranged.

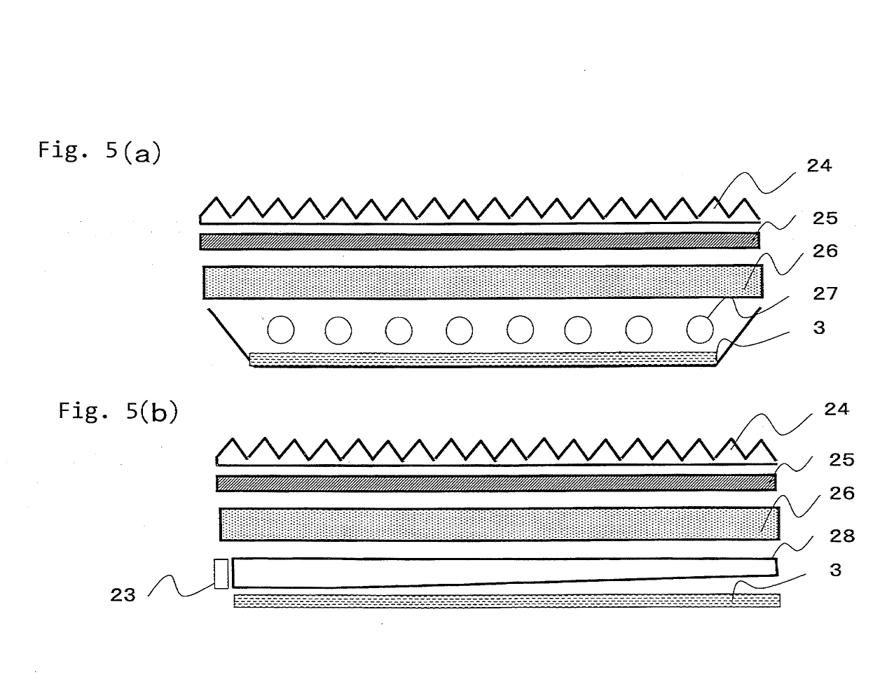

A reflecting plate for a liquid crystal display including the reflective film 3 is preferred. FIG. 5 shows a configuration in which the reflective film is used as a backlight in a liquid crystal display. FIG. 5(a) shows a configuration in which the reflective film is used as a reflecting plate of a conventional direct type backlight. FIG. 5(b) shows a configuration in which the reflective film is used as a reflecting plate of a side-light type backlight including an LED light source. The reflective film is preferably used as a reflecting plate of a side-light type backlight including an LED light source.

The LCD backlight system is an LCD backlight system comprising an LED light source 23, a reflective film 3, a light guide plate 28, a light diffusing sheet 25, and a prism sheet 24, wherein the reflective film is used which has an absolute reflectance of 95% or more at a light incidence angle of 30° or more but less than 90° at a wavelength of a blue emission spectrum from the LED light source. If necessary, a diffuser plate 26 may be used. FIG. 5(b) is an example thereof. Illumination light from an LED light source generally has a blue emission spectrum and a green to red broad emission spectrum generated by emission from a phosphor using an emission line of the blue emission spectrum as excitation light. The wavelength of a blue emission spectrum is in a wavelength range of 450 nm±30 nm, and in the side-light type LCD backlight system including an LED light source, light at the wavelength outgoes through the light guide plate mainly to the reflective film at an incidence angle in the range of 30° or more but less than 90°. Consequently, the light is reflected forward efficiently, improving the brightness of a display. The blue emission spectrum has a high intensity, and intensive reflection thereof solves a problem of a yellow tinge of displays. For optical elements such as a light guide plate, diffuser sheet, and optical adhesive used in a backlight system of a display, materials that absorb blue light are often used, which often results in a problem of the white of the display taking on a yellow tinge. From the standpoint of improvement in brightness and yellow tinge of the display, the absolute reflectance of the reflective film at a light incidence angle of 30° or more but less than 90° is preferably 95% or more, more preferably 97% or more.

Further, the LCD backlight system is preferably an LCD backlight system having an in-plane color unevenness Δx and Δy of 0.03 or less. x and y represent chromaticity, and Δx and Δy represent in-plane chromaticity unevenness and can be determined from a difference between a maximum value and a minimum value in a measurement range. The method of achievement varies depending on the optical design of the backlight, and when the reflective film has a lightness L* (SCE) of less than 15, color unevenness tends to occur due to too strong a specular reflectivity. Thus, to provide moderate diffusibility, the lightness L* (SCE) of the reflective film is preferably 22 to 70.

The reflective film has both a high reflectance and high specular reflectivity and, therefore, is preferably used as a reflective screen for a projector. The projector herein is an apparatus that magnifies image information and projects it on a screen (display unit). Specific examples thereof include a liquid crystal projector in which light from a light source is transmitted through a liquid crystal panel and an image on the liquid crystal panel is magnified and projected on a screen using a lens, and projectors of different systems such as a DLP (Digital Light Processing) projector, a CRT projector, a GLV (Grating Light Valve) projector, and an LCOS (Liquid Crystal On Silicon) projector. The light source in these projectors is equipped with a mercury lamp, a metal halide lamp, a halogen lamp, a fluorescent lamp, a white LED lamp, an RGB three-wavelength LED lamp, or the like, and preferred are LED lamps superior in terms of low power consumption. Laser projectors are more preferred in terms of convenience: for example, focusing is not necessary in magnification and projection.

The reflective film is preferably used as a solar battery back sheet. The solar battery back sheet in a silicon cell reflects light, whereby the rise in temperature of the solar battery is prevented, and light is reused, which is preferred from the standpoint of increase in generation efficiency. Further, ultraviolet rays are harmful to solar batteries, and therefore the reflective film of the present invention used as a back sheet preferably absorbs ultraviolet rays. To absorb ultraviolet rays, the thermoplastic resin used in the reflective film of the present invention preferably comprises polyethylene naphthalate. For inorganic particles, to absorb ultraviolet rays, particles of, for example, titanium oxide, zinc oxide, or barium titanate are preferably added.

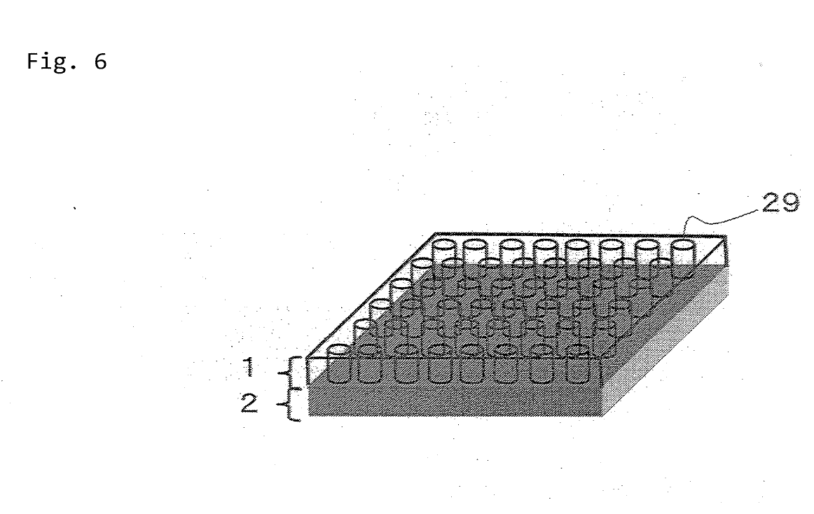

The first section is preferably perforated. FIG. 6 shows an example thereof. In the laminated film used as the first section, a plurality of pores is formed by punching, laser processing, or the like. The pore size is preferably φ1 μm to 1 mm, and the distance between adjacent pores is preferably 1 μm to 1 mm. The pore shape may be polygons such as oval, circle, hexagon, and triangle as well as geometric shapes depending on the design. The porosity per unit area is preferably 10 to 90%. For the reflective performance of the first section and the second section to not obey the additivity rule but produce a synergistic effect, the porosity is preferably 20 to 60%.

The mechanism by which the reflective performance of the first section and the second section produces a synergistic effect will be described. Without perforation, in general, light transmitted through the first section is diffusely reflected at the second section. At this time, all of the light cannot be taken out of the surface of the first section, and some of the light, in between the first section and the second section, is absorbed into the film or leaks from ends, leading to light loss. By perforation, the light loss can be reduced, and the light can be guided efficiently out of the surface of the first section.

The reflective film, after being molded, can be combined with other members for shaping. When a resin member is used as the other member, it is desirable to use insert molding. The reflective film is suited for film insert molding, and thus a molded article can be easily obtained. The method of achievement is such that a design-printed reflective film is inserted into a mold for plastic molding, and preforming such as air-pressure forming, vacuum forming, vacuum-pressure molding, or super-air-pressure forming is performed. The preformed article is then fitted into a mold of an injection molding machine, and a molding material (resin) fluidized by heating is poured into the mold to provide a molded article. In addition, TOM method can also be used which is a three-dimensional surface decoration technique in which a mold is considered as a resin molded article, and a design-printed reflective film is decorated on the resin molded article by thermoforming using vacuum/air-pressure (see of Fu-se Vacuum Forming).

### EXAMPLES

Methods of evaluating physical property values will be described.

### (Methods of Evaluating Physical Property Values)

### (1) Layer Thickness, Number of Layers, and Laminated Structure of First Section

The layer construction of a laminated film used as the first section of the reflective film was determined by observing a sample obtained by cutting the laminated film cross-sectionally with a microtome under a transmission electron microscope (TEM). That is, using a transmission electron microscope Model H-7100FA (manufactured by Hitachi Ltd.), the cross-section of the film was observed at 10,000 to 40,000× magnification at an accelerating voltage of 75 kV, and cross-section photographs were taken to determine the layer construction and the thickness of each layer. In some cases, known dyeing techniques using RuO₄, OsO₄, or the like were used to obtain high contrast.

A TEM photographic image at a magnification of about 40,000× obtained from the microscope above was processed at a printing magnification of 62,000× and stored in a personal computer as a compressed image file (JPEG), and then this file was opened using image processing software Image-Pro Plus ver. 4 (available from Planetron. Inc.) for image analysis. In the image analysis, the relationship between a position in the thickness direction and an average brightness in a region bounded by two lines in the width direction was read out as a numerical data in a vertical thick profile mode. Using a spreadsheet software (Excel 2003), data of the position (nm) and brightness after six sampling steps (six thinnings) was adopted, and then subjected to numerical processing of three-point moving average. Further, the data obtained where brightness oscillates periodically was differentiated, and the maximum value and the minimum value of the differentiation curve were read using a VBA (Visual Basic for Applications) program. The interval between these adjacent values was calculated as a layer thickness of one layer. This operation was performed for every photograph, and the layer thickness of all layers was calculated. Among the layer thicknesses obtained, layers with a thickness of 500 nm or less were defined as a thin-film layer, and layers with a thickness more than 500 nm as a thick-film layer.

### (2) Observation of Layer Construction and Voidage of Second Section

A sample was cut out from the central part in the film width direction, and cutting sections in the thickness direction and the film width direction (TD direction) of a white film used as the second section were prepared with a microtome. The cutting surfaces were then observed using a field emission scanning electron microscope JSM-6700F (manufactured by Jeol Ltd.) at a magnification of 2000 to 10000× with respect to layer construction, dispersion diameter of organic particles and inorganic particles, and the state of voids.

### (3) Measurement of Relative Average Reflectance at Wavelength of 400 to 700 Nm

A 5-cm square sample was cut out from the central part in the film width direction of a reflective film. Using a spectrophotometer (U-4100 Spectrophotomater) manufactured by Hitachi High-Technologies Corporation, a relative reflectance at an incidence angle φ of 10° was measured. The inner wall of an included integrating sphere is barium sulfate, and a reference plate is aluminum oxide. Measurements were made at a measurement wavelength of 250 nm to 1750 nm, a slit of 5 nm (visible)/automatic control (infrared), a gain of 2, and a scan rate of 600 nm/min. Subsequently, the average reflectance Rave in a wavelength range of 400 to 700 nm was determined. Light was applied to the laminated film side. For monochromatic reflective films, the relative average reflectance Rave in a wavelength range of 450 to 550 nm was also determined.

### (4) Measurement of Absolute Reflectance

### i) Reflectance of Specular Reflection Component

Using the same apparatus as in (3) above, an included angle-adjustable absolute reflectance apparatus (20-60°) P/N134-0115 (modified) was set up to measure angle-adjustable absolute reflectance. Under the same measurement conditions as in section (3), the absolute reflectance of P-wave and S-wave in a wavelength range of 250 to 1750 nm at an incidence angle of 20° and a reflection angle of 20° was measured. The size of light source masks and the size of samples were varied according to a manual of the apparatus. The absolute average reflectance Rave (20°) of P-wave and S-wave in a wavelength range of 400 nm to 700 nm [incidence angle 20°: 400 nm≦λ≦700 nm] was determined, and as represented by the following equation (1), the ratio of the absolute average reflectance Rave (20°) to the Rave in section (3) was defined as the reflectance of a specular reflection component.

Reflectance of specular reflection component=Rave(20°)/Rave×100(%) (1)

### ii) Angle-Adjustable Absolute Reflectance

The absolute reflectance of a reflective film at incidence angles of 40° and 60° was measured in the same manner as in section i) above. The average value of reflectances of P-wave and S-wave at various wavelengths was employed as a reflectance. The value at 60° was employed as a measure of central tendency at incidence angles of 30° or more but less than 90°, and a maximum value of absolute reflectance in a wavelength range of 450±30 nm or 550 nm±30 nm was determined.

iii) Synergistic Effect of Reflectance

For the synergistic effect of reflectance, the relative average reflectance of a reflective film was compared to the relative average reflectance of a laminated film used as the first section and a white film used as the second section constituting the reflective film, and based on the comparison results, evaluation was made according to the following criteria. For those having a metallic tone, the relative average reflectance at a wavelength of 400 to 700 nm was employed, and for those having a monochromatic tone, the average reflectance at a wavelength of 450 to 550 nm was employed.

Good: Having a reflectance higher than those of laminated film alone and white film alone

Fair: Having a reflectance equal to or lower by 2% or less than those of laminated film alone and white film alone

Poor: Having a reflectance lower by more than 2% than those of laminated film alone and white film alone

### (5) Particle Concentration

A solvent that dissolves polyester but does not dissolve inert particles was selected, and inert particles were separated from polyester by centrifugation. The percentage (% by weight) of the particles based on the total weight was defined as a particle concentration.

### (6) Surface Roughness

From the central part in the film width direction, a sample having a size of 4.0 cm long x 3.5 cm wide was cut out, and the surface roughness of a laminated film used as the first section and a white film used as the second section was each measured. The surface roughness (center line average roughness Ra) was measured using a three dimensional roughness analyzer SE-3AK manufactured by Kosaka Laboratory Ltd. The measurement conditions are as follows: Z.magnication: 20000, Y.drive.pitch: 10 μm, X.magnication: 200, X.drive: 100 μm/s, X.mesure length: 2000 μm.

### (7) Measurement of Voidage

An image taken at a magnification of 5,000× obtained in section (2) was captured into a personal computer. This file was then opened using image processing software Image-Pro Plus ver. 4 (available from Planetron. Inc.), and for resin part and void part, binarization processing included in the software was automatically performed.

The voidage is determined by distinguishing between the resin part (matrix resin and organic particles) and the void part using the results of the binarization image processing described above. Specifically, among measurement items on a measurement menu in Count/Size dialog box, “Area (area)” and “pre-Area (area ratio)” were selected, and Count button was pushed to perform automatic measurement. The target was the void part, and a filtering range was not considered. Subsequently, the total area ratio indicated at statistics of the measurement results was determined. When it was difficult to analyze the image, the specific gravity of a white film obtained was measured, and the voidage was calculated using a known particle density and a polyester density of 1.6.

### (8) Appearance

Based on the rate of change in glossiness of the first section before and after aging treatment at 60° C. for 24 hr under a load of 2 MPa in the state where the surface of the first section and the surface of the second section of two reflective films were laminated, evaluation was made according to the following criteria. The rate of change was determined by dividing the difference in glossiness before and after aging by the glossiness before aging and multiplying the obtained value by 100.

Good: The rate of decrease in glossiness is less than 5%
Fair: The rate of decrease in glossiness is 5% or more but less than 10%
Poor: The rate of decrease in glossiness is 10% or more

### (9) Moldability

The shape of a mold was a square pole, and the mold had a convex with a base 10 cm long and had a height of 5 cm. A molding test was performed using HDVF ultrahigh-pressure forming machine SAMK400 manufactured by Bayer and Niebling (agent: MINO GROUP Co., Ltd.). Molding was carried out under the conditions of a film temperature of 220° C., a pressure of 10 MPa, and a mold temperature of 70° C. The moldability was evaluated according to the following criteria.

Good: No wrinkle, no film breakage, and no change in color tone after molding

Fair: Slight wrinkle or slight change in color tone after molding

Poor: Wrinkle, film breakage/cracking, and color change occurred after molding

### (10) Rate of Change in Surface Roughness Ra (%)

The rate of change was determined by measuring the difference in Ra before and after aging treatment at 60° C. for 24 hr under a load of 2 MPa in the state where the surface of the first section and the surface of the second section of two reflective films in which a diffuse reflection component was controlled were laminated according to section (6), dividing the difference by Ra before aging, and multiplying the obtained value by 100.

### (11) Gloss Meter

Using a digital variable gloss meter UGV-5D (manufactured by Suga Test Instruments Co., Ltd.), glossiness at an incidence angle and a reflection angle of 60° was measured. The surface of the first section in the reflective film was highly glossy, and accordingly, a 1/10 neutral density filter was disposed for measurements. The irradiation side was the surface of the first section. The measurements were made in accordance with JIS K 7105.

### (12) Color Value (Lightness L* (SCE))

A sample of 5 cm×5 cm was cut out from the central part in the width direction of a reflective film. Using CM-3600d manufactured by Konica Minolta, Inc., the lightness L* values were measured respectively by SCE mode with specularly reflected light excluded and SCI mode with specularly reflected light included under the conditions of a target mask (CM-A106) at a measuring diameter of φ8 mm, and an average value of five measurements was determined. Calibration was carried out using a white calibration plate and a zero calibration box described below. For a light source used to calculate the color value, D65 was selected.

White calibration plate: CM-A103
Zero calibration box: CM-A104

### (13) Measurement of Brightness

The diffuser plate 26 in the configuration of FIG. 5(b) was replaced with a diffuser sheet, which was disposed on a prism sheet to measure the brightness. Specifically, a sample was cut out of a reflective film from the position of the central part in the width direction in a size of 158 mm (longitudinal direction)×203 mm (width direction). Subsequently, using a 9.7-inch edge-light type backlight unit (iPad 2 available from Apple Inc.) for evaluation, evaluation was conducted with a built-in reflective film replaced with the reflective film. After lighting for 60 minutes to stabilize a light source, using EYESCALE-3 (I-System Co., Ltd.), an included CCD camera was disposed at a point 45 cm away from the backlight surface such that it faced the backlight surface, the front brightness (cd/m²) of the whole surface was measured under the conditions of GAIN 3 and SPEED 1/100. For measurement points, the light-emitting surface was divided into 40×30 squares, and a maximum brightness value in the central 10×10 square region was employed. The rate of improvement in brightness was determined by dividing the obtained maximum front brightness by a maximum front brightness in a blank state and multiplying the obtained value by 100.

The rate of improvement in brightness was determined by the following method. The percentage of brightness based on the brightness of a white film used as the second section constituting the reflective film to be evaluated was determined. Evaluation criteria are as described below. The brightness in a blank state is a brightness measured when the white film alone used as the second section constituting the reflective film is used in the backlight unit described above.

Good: Brightness improved

Fair: Brightness equivalent

Poor: Brightness decreased

### (14) In-Plane Color Unevenness of Backlight System

Using EYESCALE-3 (I-System Co., Ltd.) used in section (13), data of x and y values were collected simultaneously with brightness. In the central 10×10 square region, Δx and Δy, differences between the maximum value and the minimum value of each of the chromaticities x and y, were determined.

### (15) Refractive Index of Transparent Adhesive Layer

The refractive index of a transparent adhesive layer was measured according to JIS K7142 (1996) A method. In Examples, the transparent adhesive layer was applied in advance to a 100-μm-thick polyester film using a meter bar under the same conditions as laminating a laminated film used as the first section and a white film used as the second section, and then cured. The solidified transparent adhesive layer was cut to a sample size of 2-cm square. This was evaluated for refractive index using an Abbe refractometer (NAR-4T available from ATAGO CO., LTD.).

### (Thermoplastic Resin)

The following resins were used as the resin A.

(Resin A-1) To a mixture of 100 parts by weight of dimethyl terephthalate and 60 parts by weight of ethylene glycol, 0.09 parts by weight of magnesium acetate and 0.03 parts by weight of antimony trioxide, the parts by weight being based on the amount of dimethyl terephthalate, were added, and the temperature was raised by heating by a conventional method to perform transesterification reaction. To the transesterification reaction product, an aqueous 85% phosphoric acid solution in an amount of 0.020 parts by weight based on the amount of dimethyl terephthalate was added, and then the resulting mixture was transferred to a polycondensation reaction layer. Further, the reaction system was gradually evacuated while raising the temperature by heating, and polycondensation reaction was performed by a conventional method under reduced pressure of 1 mmHg at 290° C. to obtain a polyethylene terephthalate having an IV of 0.61.

### (Resin A-2)

Polyethylene naphthalate having an IV of 0.43 obtained by polycondensation of naphthalene 2,6-dicarboxylic acid dimethyl ester (NDC) having an IV of 0.57 and ethylene glycol (EG) using a conventional method

### (Resin A-3)

Polyethylene naphthalate obtained by copolymerization of spiroglycol (SPG: 10 mol %) having an IV of 0.73

### (Resin A-4)

Polyethylene naphthalate obtained by copolymerization of 5 mol % of a decalin acid component having an IV of 0.58

The following resins were used as the resin B.

(Resin B-1) Polyethylene terephthalate obtained by copolymerization of cyclohexanedimethanol (CHDM: 30 mol %) having an IV of 0.72
(Resin B-2) Polyethylene terephthalate copolymer obtained by mixing the resin A-1 and the resin B-1 at 1:3
(Resin B-3) Polyethylene terephthalate obtained by copolymerization of spiroglycol (SPG: 30 mol %) having an IV of 0.73 and cyclohexanedicarboxylic acid (CHDA: 20 mol %)
(Resin B-4) Polyethylene naphthalate obtained by copolymerization of terephthalic acid (TPA: 50 mol %) having an IV of 0.63
(Resin B-4) Polyethylene terephthalate obtained by copolymerization of 10 mol % of a decalin acid (2,6-decahydronaphthalene dicarboxylic acid dimethyl) component having an IV of 0.63, 20 mol % of a cyclohexane dicarboxylic acid component, and 20 mol % of a spiroglycol component
(Resin B-5) Polyethylene terephthalate obtained by copolymerization of 17 mol % of an isophthalic acid component having an IV of 0.64

The following was used as an adhesive layer.

### (Adhesive Layer I)

An aqueous coating agent comprising an acryl/urethane copolymerized resin and a cross-linking agent of the following composition in an amount of 125 parts by weight based on 5 parts by weight of colloidal silica with a particle size of 80 nm “Composition”

Acryl/urethane copolymerized resin (A): an anionic water dispersion of acryl/urethane copolymerized resin (“Sannalon” WG-353 (trial product) available from SANNAN CHEMICAL INDUSTRY CO., LTD.). The water dispersion was produced at a solid content weight ratio of acrylic resin component/urethane resin component (polycarbonate) of 12/23 using 2 parts by weight of triethylamine.

### Oxazoline Compound (B):

Aqueous oxazoline-containing polymer dispersion

### Carbodiimide Compound (C):

Aqueous carbodiimide cross-linking agent

### Polythiophene Resin (D):

Polyethylenedioxythiophene

### Solid Content Weight Ratio:

(A)/(B)/(C)/(D)=100 parts by weight/30 parts by weight/30 parts by weight/8 parts by weight

The following was used as a transparent adhesive layer.

### (Transparent Adhesive Layer)

Transparent adhesive layers formed by the wet coating method below using adhesives (I), (IV) to (VI) as a material of a transparent adhesive layer for laminating the first section and the second section, and transparent adhesive layers formed by the dry lamination method using tackifiers (II) and (III) were used. The adhesives (IV) to (VI) were aged under the conditions of 80° C. for 2 minutes after lamination, and then the adhesives (V) and (VI) were cured by UV irradiation under the conditions of 600 mJ/cm². Meter bars used were changed from #6 to 40 depending on the coating thickness from 3 to 20 μm.

### (I) Adhesive Used in Wet Coating Method

One hundred parts by weight of a 70/30 mixed solution of polyester resin/epoxy resin (A) (AD76P1 available from Toyo-Morton, Ltd.) and 10 parts by weight of isocyanate (B) (CAT10 available from Toyo-Morton, Ltd.) were dissolved in a solvent (toluene/methyl ethyl ketone=1/1 (weight ratio) mixed solvent) such that the solid content was 32% by weight to prepare an adhesive. This was used to produce a transparent adhesive layer (I). Its refractive index was 1.55.

### (II) Tackifier Used in Dry Lamination Method (OCA)

Acrylic tackifier TD06A available from TOMOEGAWA Co., Ltd. was used. This was dry-laminated to a thickness of 25 μm to produce a transparent adhesive layer (II). Its refractive index was 1.5.

### (III) Tackifier in Dry Lamination Method (OCA)

Optical tackifier SK-1478 available from Soken Chemical & Engineering Co., Ltd. was used. This was dry-laminated to a thickness of 25 μm to produce a transparent adhesive layer (III). Its refractive index was 1.48.

### (IV) Adhesive Used in Wet Coating Method

Base resin A: polyester resin (PESRESIN S-180) available from TAKAMATSU OIL & FAT CO., LTD.
Curing agent B: isocyanate (N3300) available from Sumika Bayer Urethane Co., Ltd.
Solvent C: MEK

The above solvent was mixed at a weight ratio of A/B/C=65/13/22 to prepare an adhesive, and this was used to produce a transparent adhesive layer (IV). Its refractive index was 1.59.

### (V) Adhesive in Wet Coating Method

Base resin A: acryl (B100H) available from SHIN-NAKAMURA CHEMICAL CO., LTD.
Curing agent B: photoinitiator (IR184) available from BASF SE

### Solvent C: MEK

The above solvent was mixed at a weight ratio of A/B/C=61/3/36 to prepare an adhesive, and this was used to produce a transparent adhesive layer (V). Its refractive index was 1.53.

### (VI) Adhesive in Wet Coating Method

Base resin A: acryl (ARONIX M-215) available from TOAGOSEI CO., LTD.

Curing agent B: photoinitiator (IR184) available from BASF SE

Solvent C: MEK

The above solvent was mixed at a weight ratio of A/B/C=59/3/38 to prepare an adhesive, and this was used to produce a transparent adhesive layer (VI). Its refractive index was 1.5.

The following white films were used as the white film used as the second section.

### (White Film A)

Through the compounding in a known twin-screw extruder (L/D=45), a polyethylene terephthalate pellet containing rutile-type titanium oxide particles having an average particle size of 0.3 μm in an amount of 50% by weight based on (resin A-1) was produced (master pellet 1). The master pellet 1 was then diluted such that the weight concentration of titanium oxide in the particles having a number average particle size of 0.3 μm was 15% by weight, and further, a polyethylene terephthalate pellet containing aggregated silica having an average particle size of 4 μm in an amount of 0.08% by weight was produced (master pellet 2).

The master pellet 2 was dried at 180° C. for 3 hours, fed to a vented twin-screw kneading extruder, and melted at 280° C. The resulting polymer was filtered with high precision, fed to a T-die, extruded through a die lip into a sheet, and then using an electrostatic casting method, wound around a casting drum at 30° C. and solidified by cooling to produce an unstretched film. The unstretched film was stretched 3.3-fold in the longitudinal direction at 85° C., and then stretched 3.5-fold in the width direction at a temperature of 90 to 100° C., after which the stretched film was heat set at a heat treatment temperature of 220° C., and subjected to a 6% relaxation treatment in the width direction to obtain a white film A with a thickness of 50 μm.

### (White Film B)

For the master pellet 1, the polyethylene terephthalate pellet diluted such that the content of titanium oxide in the particles was 15% by mass was dried at 180° C. for 3 hours, fed to a vented twin-screw kneading extruder 1, and melted at 280° C. (polymer A). Further, another extruder 2 was provided, and a polyethylene terephthalate pellet containing aggregated silica having a number average particle size of 2.5 μm in an amount of 0.04% by mass (master pellet 3) was dried at 180° C. for 3 hours, fed to the extruder, and melted at 280° C. (polymer B). The two polymers were separately filtered with high precision, and then laminated at a three-layer joint block provided with a rectangular lamination unit such that the polymer A was at a base layer that serves as a diffuse reflection layer and the polymer B was at outer layers on both sides. The laminate was fed to a T-die, extruded through a die lip into a sheet, and then using an electrostatic casting method, wound around a casting drum at 30° C. and solidified by cooling to produce an unstretched film. The unstretched film was stretched 3.3-fold in the longitudinal direction at 85° C., and then stretched 3.5-fold in the width direction at a temperature of 90 to 100° C., after which the stretched film was heat set at a heat treatment temperature of 220° C., and subjected to a 6% relaxation treatment in the width direction to obtain a white film B with a thickness of 60 μm having a three-layer laminated structure. Its outer layer thickness was 5 μm.

### (White Film C)

Through the compounding in a known twin-screw extruder (L/D=45), 20% by mass of norbornene-ethylene copolymer (cycloolefin copolymer), 20% by mass of polyethylene terephthalate copolymer containing 30 mol % of cyclohexanedimethanol (resin B-1), and 60% by mass of polyethylene terephthalate (resin A-1) were melt-kneaded to produce a polyester master pellet 4 containing organic particles.

The master pellet 4 was dried at 150° C. for 3 hours, fed to the vented twin-screw kneading extruder 1, and melted at 280° C. (polymer A). Further, the other extruder 2 was provided, and the master pellet 3 was dried at 180° C. for 3 hours, fed to the extruder, and melted at 280° C. (polymer B). The two polymers were separately filtered with high precision, and then laminated at a three-layer joint block provided with a rectangular lamination unit such that the polymer A was at a base layer and the polymer B was at outer layers on both sides. The laminate was fed to a T-die, extruded through a die lip into a sheet, and then using an electrostatic casting method, wound around a casting drum at 30° C. and solidified by cooling to produce an unstretched film. The unstretched film was stretched 3.3-fold in the longitudinal direction at 85° C., and then stretched 3.5-fold in the width direction at a temperature of 90 to 100° C., after which the stretched film was heat set at a heat treatment temperature of 220° C., and subjected to a 6% relaxation treatment in the width direction to obtain a white film C with a thickness of 60 μm having a three-layer laminated structure. Its outer layer thickness was 5 μm.

### (White Film D)

Through the compounding in a known twin-screw extruder (L/D=45), 12% by mass of norbornene-ethylene copolymer (cycloolefin copolymer), 18% by mass of barium sulfate having an average particle size of 0.6 μm, 15% by mass of polyethylene terephthalate copolymer containing 17 mol % of isophthalic acid (resin B-5), and 55% by weight of polyethylene terephthalate (resin A-1) were melt-kneaded to produce a polyester master pellet 5 containing organic and inorganic particles.

The master pellet 5 was used as the polymer A at a base layer. The master pellet 3 was used as the polymer B at outer layers.

The same procedure as in the case of the white film C was repeated except the polymer A at a base layer to obtain a white film D with a thickness of 150 μm having a three-layer laminated structure. Its outer layer thickness was plane and 5 μm.

### (White Film E)

Through the compounding in a known twin-screw extruder (L/D=45), 12% by mass of norbornene-ethylene copolymer (cycloolefin copolymer), 18% by mass of titanium oxide having an average particle size of 0.3 μm, 9% by mass of polyethylene terephthalate copolymer containing 30 mol % of cyclohexanedimethanol (resin B-1), 58% by mass of polyethylene terephthalate (resin A-1), and 3% by mass of a compatibilizer were added and melt-kneaded to produce a polyester master pellet 6 containing organic and inorganic particles. The master pellet 6 was used at a base layer as the polymer A.

Further, pellets of 12% by mass of barium sulfate having an average particle size of 0.6 μm, 20% by mass of polyethylene terephthalate copolymer containing 17 mol % of isophthalic acid (resin B-5), and 68% by mass of polyethylene terephthalate (resin A-1) were melt-kneaded to produce a master pellet 7. The master pellet 7 was used at outer layers as the polymer B.

The same procedure as in the case of the white film C was repeated except the polymer A at a base layer and the polymer B at outer layers to obtain a white film E with a thickness of 150 μm having a three-layer laminated structure. Its outer layer thickness was 5 μm.

### (White Film F)

The same polyester master pellet 5 containing organic and inorganic particles as in the white film D was used at a base layer as the polymer A.

Pellets of 2.4% by mass of aggregated silica having an average particle size of 4 μm, 50% by mass of polyethylene terephthalate copolymer containing 17 mol % of isophthalic acid (resin B-5), and 47.6% by mass of polyethylene terephthalate (resin A-1) were melt-kneaded to produce a master pellet 8. The master pellet was used at outer layers as the polymer B.

The same procedure as in the case of the white film C was repeated except the polymer A at a base layer and the polymer B at outer layers to obtain a white film E with a thickness of 150 μm having a three-layer laminated structure. Its outer layer thickness was 5 μm.

Evaluation results of the white films A to F are shown in Table 1-1.

The resins in Examples and Comparative Examples were used in the combinations shown in Tables 1-2 to 1-4.

### Example 1

### Formation of Laminated Film Used as the First Section

The resin A-2 was vacuum-dried at 180° C. for 3 hours, while the resin B-3 was dried at 100° C. under nitrogen, and on a closed conveyor line, they were separately charged into two twin-screw extruders, each melted at an extrusion temperature of 290° C. and 280° C., and kneaded. At the bottom of a hopper, nitrogen purging was carried out. Subsequently, foreign matter such as oligomers and impurities was removed from two vent holes by vacuum venting at a vacuum pressure of 0.1 kPa or less. The ratios of material feed rate to screw speed (Q/Ns) of the twin-screw extruders were each set at 2 and 1.5. The resins were each filtered through 10 FSS-type leaf disk filters with a filtration accuracy of 6 μm, and then, while being weighed at a gear pump such that the discharge ratio (lamination ratio) of the thermoplastic resin A to the thermoplastic resin B was 1/1, joined at a 801-layer laminating apparatus in the same manner as for the laminating apparatus disclosed in Japanese Patent No. 4552936 to provide a laminate in which the resins were alternately laminated in the thickness direction in 801 layers. The laminate had a layer thickness distribution having three slant structures shown in FIG. 3 for both the A layer and the B layer, as described in paragraphs [0034] to [0036] of JP 2011-129110 A, and the outermost layer was a thick-film layer. In one slant structure, the A layer and the B layer were alternately laminated in 267 layers, and the laminated film was designed such that the three slant structures were arranged such that the layer thickness was thinnest near the both surfaces. Further, for the three slant structures, in designing a thin-film layer of the slant structure of the A layer or the B layer, a slit design in which a gradient, the ratio of maximum layer thickness/minimum thickness, was 2.8 was employed. The laminate was then fed to a T-die, and molded into a sheet, after which, while applying an electrostatic voltage of 8 kV with a wire, the sheet was solidified by rapid cooling on a casting drum with a surface temperature maintained at 25° C. to obtain an unstretched film. The unstretched film was stretched 3.2-fold in the film longitudinal direction at 145° C. using a longitudinal stretching machine, corona treated, and provided with the adhesive layer I on one surface using a #4 meter bar. The resulting film was then guided to a tenter where both ends are held by clips, and transversely stretched 3.4-fold in the film width direction at 150° C., after which the stretched film was heat treated at 240° C. and relaxed in the film width direction at 150° C. by about 3% to obtain a laminated film with a thickness of 100 μm. The layer thickness distribution of the laminated film obtained included three slant structures for both the A layer and the B layer, wherein for the thin-film layer, the layer thickness of both the A layer and the B layer monotonously increased from the outer layer sides to the 267th layer. The remaining 267 layers at the central part in the film thickness direction also had an slant structure. The thick-film layer at the outer layer was 5 μm thick. A laminated film used as the first section having glossiness could be obtained. The laminated film had a uniform relative reflectance in a wavelength range of 400 to 700 nm, as measured with a spectrophotometer, and a relative average reflectance of 100%, and was colorless silver white with a metallic tone.

### (Lamination to White Film Used as the Second Section)

The obtained laminated film used as the first section and the white film C were laminated to each other using a roll laminator. The transparent adhesive layer (I) was applied to a non-adhesive side of the laminated film with a gravure coater, and laminated to the white film with a nip roll. Subsequently, to dry and remove solvent, the laminate was passed through a hot-air oven at 70° C., and wound up on a roll to obtain a reflective film. The thickness of the transparent adhesive layer was 4 μm, and the reflective film obtained was a film that was highly reflective in the visible-light region and completely specular, but was almost nonreflective in the UV region at a wavelength of 400 nm or less. Even when the film obtained was relaxed at 60° C., no change occurred in glossiness at the roll core or at the outer layer, and no irregularities were observed at the laminated film side. As a result of lamination of the two films, the relative average reflectance was 101%, which was higher than the reflectance of each of the laminated film and the white film. The properties are shown in Table 1-1 and Table 1-2.

### Example 2

A reflective film was obtained in the same manner as in Example 1 except that the resin A-2 was substituted with the resin A-3 and the heat treatment temperature was lowered to 220° C. The film obtained was a reflective film that was colorless and specular and had excellent moldability. The relative average reflectance of the laminated film was 98%. As a result of lamination of the two films, the relative average reflectance was 99%, which was higher than the reflectance of each of the laminated film and the white film.

### Example 3

The resins in Example 2 were substituted with the resin A-1 and the resin B-1, which were charged into two twin-screw extruders, melted at 280° C., and kneaded. Thereafter, the same procedure as in Example 1 was repeated to obtain an unstretched film. The unstretched film was stretched 3.2-fold in the film longitudinal direction at 95° C. using a longitudinal stretching machine, corona treated, and provided with the adhesive layer I on one surface using a #4 meter bar. The resulting film was then guided to a tenter where both ends are held by clips, and transversely stretched 3.5-fold in the film width direction at 110° C., after which the stretched film was heat treated at 230° C. and relaxed in the film width direction at 150° C. by about 3% to obtain a laminated film with a thickness of 100 μm. The layer thickness distribution of the laminated film obtained included the three slant structures shown in FIG. 3 for both the A layer and the B layer, wherein for the thin-film layer, the layer thickness of both the A layer and the B layer monotonously increased from the outer layer sides to the 267th layer. The remaining 267 layers at the central part in the film thickness direction also had an slant structure. The thick-film layer at the outer layer was 5 μm thick. A laminated film used as the first section having glossiness could be obtained. The laminated film had a uniform relative reflectance in a wavelength range of 400 to 700 nm, as measured with a spectrophotometer, and a relative average reflectance of 50%, and was colorless with a metallic tone. Further, the same procedure as in Example 1 was repeated to obtain a reflective film. As a result of lamination of the two films, the relative average reflectance was higher than the reflectance of each of the laminated film and the white film.

### Example 4

An unstretched film was obtained in the same manner as in Example 1 using the resin A-2 and the resin B-4. Skipping the longitudinal stretching machine, the unstretched film was then corona treated, and provided with the adhesive layer I on one surface using a #4 meter bar. The resulting film was then guided to a tenter where both ends are held by clips, and transversely stretched 5-fold in the film width direction at 150° C., after which the stretched film was heat treated at 160° C. and relaxed in the film width direction at 150° C. by about 3% to obtain a uniaxially oriented laminated film with a thickness of 100 μm. The laminated film had a uniform relative reflectance in a wavelength range of 400 to 700 nm, as measured with a spectrophotometer, and a relative average reflectance of 52%, and was colorless with a metallic tone. Further, the same procedure as in Example 1 was repeated to obtain a reflective film. As a result of lamination of the two films, the average reflectance was higher than the reflectance of each of the laminated film and the white film. The laminated film had poor moldability due to its strong anisotropy.

### Example 5

A laminated film with a thickness of 100 μm used as the first section was obtained in the same manner as in Example 3 except that the materials were changed as shown in Table 1-2. The laminated film had a relative average reflectance of 70% and a uniform reflectance at a wavelength of 400 to 800 nm and, therefore, was colorless with a metallic tone. Further, after film formation, the laminated film used as the first section was subjected to punching process of a diameter of 300 μm, a voidage of 35%, and a hole interval of 100 μm. The average reflectance after the punching process was 45%. Since the holes were punched, the laminated film was laminated to the white film using (II) the tackifier in the dry lamination method (OCA) to thereby produce a reflective film. A film with excellent designability and increased reflection efficiency as shown in FIG. 6 was obtained. As a result of lamination of the two films, the relative average reflectance was higher than the reflectance of each of the laminated film after the punching process and the white film.

### Examples 6 to 7

A laminated film with a thickness of 100 μm used as the first section was obtained in the same manner as in Example 3 except that the materials were changed as shown in Table 1-2. The relative average reflectance of the laminated film of Example 6 was 37%, and the relative average reflectance of Example 7 was 70%. As a result of lamination of the two films using the same lamination method as in Example 1, the relative average reflectances of the reflective films obtained was both higher than the reflectance of each of the laminated film and the white film. In Example 7, inorganic particles were used in the white film, thus resulting in poor moldability.

### Comparative Example 3

A laminated film with a thickness of 100 μm used as the first section was obtained in the same manner as in Example 6 except that the materials were changed as shown in Table 1-2. In Comparative Example 3, the surface roughness of the white film A transferred during aging treatment after winding. In Comparative Example 3, the interface between the laminated film used as the first section and the laminated film used as the second section was rough, and therefore in the reflective film obtained, an improvement in relative average reflectance due to lamination of the two films was not observed. In other words, the relative average reflectance was lower than the reflectance of each of the laminated film and the white film. FIG. 8 shows the reflectance properties.

### Comparative Example 1

A laminated film used as the first section was obtained in the same manner as in Example 5 except that the materials were changed as shown in Table 1-2. In Comparative Example 1, the white film A was laminated in the same manner as in Example 5. After relaxation treatment at 60° C. after winding, the surface roughness of the white film A transferred to the opposite laminated film side, and glossiness of the surface was reduced at the roll core part. Since the interface between the laminated film used as the first section and the laminated film used as the second section was rough, as a result of lamination of the two films, the average reflectance of the reflective film obtained was lower than the reflectance of each of the laminated film and the white film.

### Comparative Example 2

Using the materials the resin A-1 and the resin B-2, the same procedure as in Example 3 was repeated to produce a laminated film, which was used as a reflective film. Although the reflective film was glossy compared to common transparent films, the reflectance was as low as 34%, and it was not available for use as a reflector in lighting applications and the like.

### Examples 9 to 11

### Formation of Laminated Film Used as the First Section

A laminated film with a thickness of 100 μm used as the first section was obtained in the same manner as in Example 1 except that the materials were changed as shown in Table 1-3. The thickness of the outermost layer was 5 μm. The laminated film obtained was uniformly reflective over a wavelength of 400 to 800 nm, and had a relative average reflectance of 97%, presenting a metallic tone.

### (Lamination to White Film Used as the Second Section)

The white films D, E, and F to be laminated to the obtained laminated film used as the first section were provided. The transparent adhesive layer (III) was laminated to a non-adhesive side of the laminated film and laminated to the white film with a nip roll to obtain a reflective film. The thickness of the transparent adhesive layer was 25 μm, and the reflective film obtained was a film that was highly reflective in the visible-light region and completely specular, but was almost nonreflective in the UV region at a wavelength of 400 nm or less. Even when the reflective film obtained using the white film D or E having a plane surface was relaxed at 60° C., no change occurred in glossiness at the roll core or at the outer layer, and no irregularities were observed at the laminated film side. For the reflective film obtained using the white film F, since the surface irregularities of the white film were significant, a synergistic effect of relative average reflectance particularly due to lamination of the two films could not be observed clearly. For Example 9 and Example 10, the reflectance was 98% or more, which was higher than the reflectance of each of the laminated film and the white film. Their properties are shown in Table 1-1 and Table 1-3.

### Examples 12 to 14

A laminated film with a thickness of 52 μm used as the first section was obtained in the same manner as in Example 3 except that the materials were changed as shown in Table 1-3 and the 801-layer laminating apparatus was substituted with a 491-layer laminating apparatus. The thickness of the outermost layer was 5 μm. The laminated film had an average reflectance of 59% and a monochromatic tone of blue-green to blue iridescent color. It was a narrow-band interference reflecting film having a reflection wavelength range of 450 to 550 nm. The layer thickness distribution of the laminated film obtained had an slant structure in which there were two slant structures symmetrically at the back and front in which the layer thickness increases from an outer layer toward the central part in the film thickness direction. A slit design in which the gradient of the apparatus was 1.4 was employed.

### (Lamination to White Film Used as the Second Section)

The white films D, E, and F to be laminated to the obtained laminated film used as the first section were provided, and the same procedure as in Examples 9 to 11 was repeated to obtain a reflective film. For all of the reflective films, the relative average reflectance at a wavelength of 400 to 700 nm is lower than that of the original white film, but in the reflection band at a wavelength of 450 to 550 m, the synergistic effect of reflectance can be observed.

Their spectral reflectance properties are shown in Table 1-1, Table 1-3, and FIG. 7.

### Comparative Example 5

A laminated film was obtained in the same manner as in Example 14 except that the thickness of the outermost layer of the laminated film used as the first section was 1 μm. The white film F was then laminated to obtain a reflective film. Since the surface irregularities of the white film F were significant, the irregularities transferred to the laminated film side, resulting in poor appearance, and the synergistic effect of reflectance could not be observed at all. Their properties are shown in Table 1-1 and Table 1-3.

### Example 15

The outermost layer thickness of the laminated film (no punching) used as the first section obtained in Example 5 was changed to 1 μm, and the laminated film was laminated, as shown in Table 1-3, to the white film D to obtain a reflective film. Since the surface of the white film D was plane, there was no particular problem with appearance. However, the relative average reflectance was not higher than that of the white film (98%), and the synergistic effect of reflectance could not be produced. Their properties are shown in Table 1-1 and Table 1-3.

### Example 16

A 100-μm-thick laminated film was obtained in the same manner as in Example 15 except that the resin A of the laminated film was a polyethylene terephthalate to which 0.32% by weight of aggregated silica having an average particle size of 0.6 μm was added. The laminated film, as compared to the laminated film of the first section of Example 15, had a mat tone, an average reflectance as low as 68%, and a rough surface. The laminated film was then laminated to the white film D in the same manner to obtain a reflective film. Since the surface of the white film D was plane, there was no particular problem with appearance, but the relative average reflectance was 95%, which was significantly lower than that of the white film (98%). The properties are shown in Table 1-1 and Table 1-3.

### Example 17

The laminated film used as the first section obtained in Example 6 was laminated to the white film D to obtain a reflective film. Since the surface of the white film D was plane, there was no particular problem with appearance, but because of a great light returning effect due to a significantly low relative average reflectance of the first section, the relative average reflectance was 94%, which was significantly lower than the relative average reflectance of the white film (98%). The properties are shown in Table 1-1 and Table 1-3.

### Comparative Examples 6 to 7

The reflective films comprising only the laminated film used as the first section used in Examples 9 to 11 and Examples 12 to 14 had an average reflectance of 97% and 59%. They were reflective films having high specular reflectivity and no diffusibility. The properties are shown in Table 1-1, Table 1-3, and FIG. 7.

### Examples 18 to 20

The same films as the laminated film of the first section and the white film D of the second section in Example 9 were laminated via the transparent adhesive layer (IV), and the synergistic effect of reflectance due to the thickness of the transparent adhesive layer (IV) was investigated. The relative average reflectances in Examples 18 to 20 were higher than 98%, and thus the synergistic effect of reflectance could be confirmed in all of them. In particular, it was found that Example 18 where the thickness of the transparent adhesive layer was as thin as 3 μm was most effective. The properties are shown in Table 1-1 and Table 1-4.

### Examples 21 to 24

The same films as the laminated film of the first section and the white film D of the second section in Example 12 were laminated via the transparent adhesive layers (IV) to (VI) or air, and the synergistic effect of reflectance due to the refractive index of the transparent adhesive layers was investigated. We found that the reflective film of Example 23 having a refractive index of 1.59 produced the greatest synergistic effect of reflectance. Since the laminated film of the first section had a monochromatic tone, this effect could be clearly confirmed in the relative average reflectance at a wavelength of 450 to 550 nm which was its reflection band. In Example 24, air was used as the transparent layer, and therefore the first section and the second section were superimposedly arranged without using a transparent adhesive to obtain a reflective film. The evaluation results were shown in Table 1-1 and Table 1-4.

### Example 25

A laminated film used as the first section was obtained in the same manner as in Example 12 except that the materials were changed as shown in Table 1-4. The laminated film was then laminated to the white film D. A good reflective film with good appearance and a synergistic effect of reflectance was obtained. The evaluation results were shown in Table 1-1 and Table 1-4.

### Example 26

A laminated film used as the first section was obtained in the same manner as in Example 9 except that the materials were changed as shown in Table 1-4. The laminated film was then laminated to the white film D. A good reflective film with good appearance, high moldability, and a high synergistic effect of reflectance was obtained. The evaluation results were shown in Table 1-1 and Table 1-4.

### Example 27

The same materials as in Example 25 were used. For the laminated film of the first section, similarly to Example 12, the resin A-1 and the resin B-5 were separately charged into two twin-screw extruders, melted at 280° C., and kneaded. The resins were then alternately laminated in a 491-layer laminating apparatus (feed block), flown through a flow path as a 491-layer laminated flow, and fed to an α-layer flow path of a pinole (combiner: two-layer composite α/β). Meanwhile, a third extruder was provided, and the master pellet 5 that becomes a base layer of the white film D used as the second section was charged, melted, and kneaded. The resultant was then fed to a β-layer flow path of the pinole. The laminated flow from the α-layer which becomes the first section and the polymer alloy resin flow from the β-layer which becomes the second section were joined in the pinole, and, in an integrally melt-molded state, extruded through a die lip into a sheet to obtain an unstretched film.

Subsequently, a reflective film with a thickness of 202 μm was obtained under the same film-forming conditions as in Example 3.

A cross-section was observed under a scanning electron microscope, and we found that the reflective film had a structure in which the laminated surface at the first section side was plane because the outermost layer of the first section was a 5-μm thick-film layer, and there was no interface because the same resin was used at a part corresponding to a conventional transparent adhesive layer. The synergistic effect of reflectance could be sufficiently confirmed because diffuse reflection in the second section was prevented from leaking out of the transparent adhesive layer provided by the above post-process. Further, there was no problem with moldability or appearance, and good results were obtained. The properties are shown in Table 1-1 and Table 1-4.

### Example 28 to Example 36, and Comparative Example 8 to Comparative Example 13

Using the white films D, E, and F having a function mainly of a reflecting plate in LCD backlight systems as a reference of brightness, the rate of improvement in brightness was investigated in the cases where the reflective films of Examples 9 to 14 and 15 to 17, which are our examples, and the reflective films of Comparative Examples 5 to 7 were used.

It can be seen from the results in Table 1-5 that in any of Examples 28, 29, 31, and 32 where the films to be evaluated produced the synergistic effect of reflectance, brightness improved to more than the value of the original white film used as the second section. On the other hand, in Example 30 and Example 33 where the reflective film did not change in average reflectance performance, brightness did not substantially change. Further, in Comparative Example 8, Example 34, Example 35, and Example 36 where the reflective performance decreased, although the interface with the white film was plane, the reflectance was sufficiently low compared to that of the original white film of the second section; therefore the synergistic effect of reflectance was not produced, and brightness showed the same tendency. The reflective film of Comparative Example 9 was a reflective film with a metallic tone, but this alone had a brightness lower than that of the white film. Further, for the monochromatic reflective film of Comparative Example 10, the reflected color at an oblique angle was bluish, and the absolute reflectance at an incidence angle of 30 to 60° of light at an incidence angle of 60° from an LED light source was not lower than 95%. However, this alone had a low brightness as compared to that of the white film. The in-plane color unevenness Δx and Δy of the backlight systems using Examples 28, 29, 31, and 32 where improvement in brightness was observed were all 0.03 or less, indicating that a sufficiently practicable LCD backlight system was constructed.

### Comparative Example 14

A laminated film was formed in the same manner as the laminated film used as the second section used in the reflective film of Example 12, except that the thickness was changed to 90 μm. The laminated film was a narrow-band interference reflecting film that reflects in a reflection band at a wavelength of 700 nm to 900 nm. The laminated film was then laminated in the same manner to the white film to evaluate brightness. At a light incidence angle of 30 to 60°, the absolute reflectance of the reflective film in a wavelength range of 450±30 nm was less than 95%. Further, improvement in brightness could not be observed, and the color tone of a display was tinted, indicating that the reflective film was impractical as a reflective film.

TABLE 1-1

| | | | White film | White film | White film | White film | White film | White film |
|---|---|---|---|---|---|---|---|---|
| | | Unit | A | B | C | D | E | F |
| Second section | Layer construction | | one layer | three layers | three layers | three layers | three layers | three layers |
| | Polymer B at outer | — | | A-1 | A-1 | A-1 | A-1 + B-5 | A-1 + B-5 |
| | layers | | | | | | | |
| | Polymer A at base layer | — | A-1 | A-1 | A-1 + B-1 | A-1 + B-5 | A-1 + B-1 | A-1 + B-5 |
| | (resin C) | | | | | | | |
| | Voidage | % | less than 1 | less than 1 | 44 | 47 | 40 | 48 |
| | Additional particles | — | titanium | titanium | cycloolefin | cycloolefin/ | cycloolefin/ | cycloolefin/ |
| | | | oxide | oxide | | barium | titanium | barium |
| | | | | | | sulfate | oxide | sulfate |
| | Concentration | % | 15 | 15 | 20 | 12/18 | 12/18 | 12/18 |
| | Thickness | μm | 50 | 60 | 60 | 150 | 150 | 150 |
| | Surface roughness Ra | nm | 210 | 32 | 22 | 18 | 70 | 358 |
| Reflectance of | Absolute average | % | 1.0 | 2.3 | 2.3 | 7.6 | 3.6 | 1.5 |
| specular reflection | reflectance at incidence | | | | | | | |
| component | angle of 20°/relative | | | | | | | |
| | average reflectance | | | | | | | |
| Absolute average | Rave (20°) | % | 0.85 | 2.00 | 2.00 | 7.4 | 3.5 | 1.5 |
| reflectance at | | | | | | | | |
| incidence angle of 20° | | | | | | | | |
| Relative average | Wavelength of 400 to | % | 87 | 87 | 87 | 98 | 98 | 98 |
| reflectance | 700 nm | | | | | | | |
| Glossiness | | — | 39 | 67 | 80 | 122 | 60 | 34 |

TABLE 1-2

| | | | Example | Example | Example | Example | Example |
|---|---|---|---|---|---|---|---|
| | | Unit | 1 | 2 | 3 | 4 | 5 |
| First section | Resin A | | A-2 | A-3 | A-1 | A-2 | A-1 |
| | Resin B | | B-3 | B-3 | B-1 | B-4 | B-3 |
| | Surface roughness | nm | 4 | 2 | 4 | 3 | 3.5 |
| | Thickness of outermost layer | μ | 5 | 5 | 5 | 5 | 5 |
| | Relative average reflectance | % | 100 | 98 | 50 | 52 | 45 |
| | Reflected color | — | Metallic | Metallic | Metallic | Metallic | Metallic |
| | | | | | | | (punched) |
| Second section | White film | — | C | C | C | C | C |
| Transparent adhesive | Resin | — | I | I | I | I | II |
| layer | Thickness | μm | 4 | 4 | 4 | 4 | 25 |
| | Refractive index | — | 1.55 | 1.55 | 1.55 | 1.55 | 1.5 |
| Reflectance of specular | Absolute average reflectance | % | 98 | 98 | 56 | 54 | 19 |
| reflection component | at incidence angle of | | | | | | |
| | 20°/relative average | | | | | | |
| | reflectance | | | | | | |
| Absolute average | Rave (20°) | % | 99 | 97 | 49 | 50 | 18 |
| reflectance at incidence | | | | | | | |
| angle of 20° | | | | | | | |
| Relative average | Wavelength of 400 to 700 nm | % | 101 | 99 | 88 | 93 | 93 |
| reflectance | | | | | | | |
| Glossiness | | | 910 | 900 | 650 | 680 | 200 |
| Colorimeter | Lightness L* (SCE) | | 22 | 23 | 73 | 72 | 90 |
| Moldability | | — | Fair | Good | Good | Fair | Good |
| Rate of change in surface | | % | 12 | 15 | 25 | 22 | |
| roughness Ra | | | | | | | |
| Synergistic effect of reflectance | | — | Good | Good | Good | Good | Good |
| Appearance | | | Good | Good | Good | Good | Good |
| | | | Example | Example | Comparative | Comparative | Comparative |
| | | Unit | 6 | 7 | Example 1 | Example 2 | Example 3 |
| First section | Resin A | | A-1 | A-1 | A-1 | A-1 | A-1 |
| | Resin B | | B-2 | B-3 | B-3 | B-2 | B-2 |
| | Surface roughness | nm | 5.5 | 6.5 | 8.5 | 5.5 | 6 |
| | Thickness of outermost layer | μ | 5 | 5 | 1 | 1 | 1 |
| | Relative average reflectance | % | 37 | 70 | 70 | 34 | 37 |
| | Reflected color | — | Metallic | Metallic | Metallic | Metallic | Metallic |
| Second section | White film | — | C | B | A | | A |
| Transparent adhesive | Resin | — | I | I | I | | I |
| layer | Thickness | μm | 4 | 4 | 4 | | 4 |
| | Refractive index | — | 1.55 | 1.55 | 1.55 | | 1.55 |
| Reflectance of specular | Absolute average reflectance | % | 37 | 76 | 76 | 97 | 32 |
| reflection component | at incidence angle of | | | | | | |
| | 20°/relative average | | | | | | |
| | reflectance | | | | | | |
| Absolute average | Rave (20°) | % | 32 | 68 | 65 | 33 | 27 |
| reflectance at incidence | | | | | | | |
| angle of 20° | | | | | | | |
| Relative average | Wavelength of 400 to 700 nm | % | 87 | 90 | 85 | 34 | 84 |
| reflectance | | | | | | | |
| Glossiness | | | 465 | 780 | 751 | 467 | 440 |
| Colorimeter | Lightness L* (SCE) | | 76 | 48 | 56 | 19 | 85 |
| Moldability | | — | Good | Fair | Fair | Fair | Fair |
| Rate of change in surface | | % | 33 | 50 | 200 | | 195 |
| roughness Ra | | | | | | | |
| Synergistic effect of reflectance | | — | Fair | Good | Poor | | Poor |
| Appearance | | | Good | Good | Poor | | Poor |

TABLE 1-3

| | | | Example | Example | Example | Example | Example | Example |
|---|---|---|---|---|---|---|---|---|
| | | Unit | 9 | 10 | 11 | 12 | 13 | 14 |
| First section | Resin A | | A-2 | | | A-1 | | |
| | Resin B | | B-1 | | | B-3 | | |
| | Surface roughness | nm | 6 | | | 6.5 | | |
| | Thickness of outermost | μ | 5 | | | 5 | | |
| | layer | | | | | | | |
| | Relative average | % | 97 | | | 59 | | |
| | reflectance | | | | | | | |
| | Reflected color | — | Metallic | | | Monochromatic | | |
| Second section | White film | — | D | E | F | D | E | F |
| Transparent adhesive | Resin | — | III | | | | | |
| layer | Thickness | μm | 25 | | | | | |
| | Refractive index | — | 1.48 | | | | | |
| Reflectance of specular | Absolute average | % | 94 | 93 | 92 | 58 | 56 | 56 |
| reflection component | reflectance at incidence | | | | | | | |
| | angle of 20°/relative | | | | | | | |
| | average reflectance | | | | | | | |
| Absolute average | Rave (20°) | % | 92 | 91 | 89 | 56 | 54 | 53 |
| reflectance at incidence | | | | | | | | |
| angle of 20° | | | | | | | | |
| Relative average | Metallic: wavelength of | % | 98.3 | 98.1 | 97 | 96.8 | 96 | 95 |
| reflectance | 400 to 700 nm | | | | | | | |
| | Monochromatic: | | | | | (100.5) | (99) | (98) |
| | wavelength of 450 to | | | | | | | |
| | 550 nm | | | | | | | |
| Glossiness | | | 900 | 890 | 878 | 741 | 730 | 698 |
| Colorimeter | Lightness L* (SCE) | — | 24 | 27 | 29 | 60 | 63 | 68 |
| Moldability | | — | Fair | Fair | Fair | Good | Good | Good |
| Rate of change in | | % | 10 | 52 | 88 | 11 | 54 | 90 |
| surface roughness Ra | | | | | | | | |
| Synergistic effect of reflectance | | — | Good | Good | Fair | Good | Good | Fair |
| Appearance | | | Good | Good | Good | Good | Good | Good |
| | | | Comparative | Example | Example | Example | Comparative | Comparative |
| | | Unit | Example 5 | 15 | 16 | 17 | Example 6 | Example 7 |
| First section | Resin A | | A-1 | A-1 | A-1 | A-1 | A-2 | A-1 |
| | Resin B | | B-3 | B-3 | B-3 | B-2 | B-1 | B-3 |
| | Surface roughness | nm | 6.5 | 6.5 | 22 | 5 | 6 | 6.5 |
| | Thickness of outermost | μ | 1 | 1 | 1 | 5 | 5 | 5 |
| | layer | | | | | | | |
| | Relative average | % | 59 | 70 | 68 | 37 | 97 | 59 |
| | reflectance | | | | | | | |
| | Reflected color | — | Monochromatic | Metallic | Metallic | Metallic | Metallic | Monochromatic |
| Second section | White film | — | F | D | D | D | | |
| Transparent adhesive | Resin | — | III | | | | | |
| layer | Thickness | μm | 25 | | | | | |
| | Refractive index | — | 1.48 | | | | | |
| Reflectance of specular | Absolute average | % | 43 | 69 | 56 | 36 | 98 | 95 |
| reflection component | reflectance at incidence | | | | | | | |
| | angle of 20°/relative | | | | | | | |
| | average reflectance | | | | | | | |
| Absolute average | Rave (20°) | % | 40 | 68 | 53 | 34 | 95 | 56 |
| reflectance at incidence | | | | | | | | |
| angle of 20° | | | | | | | | |
| Relative average | Metallic: wavelength of | % | 93 | 98 | 95 | 94 | 97 | 59 |
| reflectance | 400 to 700 nm | | | | | | | |
| | Monochromatic: | | (96.5) | | | | | |
| | wavelength of 450 to | | | | | | | |
| | 550 nm | | | | | | | |
| Glossiness | | | 487 | 771 | 553 | 466 | 895 | 740 |
| Colorimeter | Lightness L* (SCE) | — | 74 | 45 | 58 | 76 | 17 | 19 |
| Moldability | | — | Good | Good | Good | Good | Fair | Good |
| Rate of change in | | % | 250 | 60 | 150 | 32 | | |
| surface roughness Ra | | | | | | | | |
| Synergistic effect of reflectance | | — | Poor | Fair | Poor | Poor | | |
| Appearance | | | Poor | Good | Fair | Good | | |

TABLE 1-4

| | | | Example | Example | Example | Example | Example |
|---|---|---|---|---|---|---|---|
| | | Unit | 18 | 19 | 20 | 21 | 22 |
| First section | Resin A | | A-2 | | | A-1 | |
| | Resin B | | B-1 | | | B-3 | |
| | Surface roughness | nm | 6 | | | 6.5 | |
| | Thickness of outermost | μ | 5 | | | 5 | |
| | layer | | | | | | |
| | Relative average | % | 97 | | | 59 | |
| | reflectance | | | | | | |
| | Reflected color | — | Metallic | | | Monochromatic | |
| Second section | White film | — | D | | | D | |
| Transparent adhesive | Resin | — | IV | | | VI | V |
| layer | Thickness | μm | 3 | 10 | 20 | 3 | |
| | Refractive index | — | 1.59 | | | 1.5 | 1.53 |
| Reflectance of specular | Absolute average | % | 94 | 94 | 94 | 58 | 58 |
| reflection component | reflectance at incidence | | | | | | |
| | angle of 20°/relative | | | | | | |
| | average reflectance | | | | | | |
| Absolute average | Rave (20°) | % | 93 | 93 | 92 | 56 | 56.5 |
| reflectance at incidence | | | | | | | |
| angle of 20° | | | | | | | |
| Relative average | Metallic: wavelength of | % | 99 | 98.6 | 98.3 | 97.1 | 97.2 |
| reflectance | 400 to 700 nm | | | | | | |
| | Monochromatic: | | | | | (100.8) | (101) |
| | wavelength of 450 to | | | | | | |
| | 550 nm | | | | | | |
| Glossiness | | | 900 | 899 | 895 | 741 | 742 |
| Colorimeter | Lightness L* (SCE) | — | 25 | 26 | 30 | 58 | 56 |
| Moldability | | — | Fair | Fair | Fair | Good | Good |
| Rate of change in surface | | % | 10 | 10 | 10 | 11 | 10 |
| roughness Ra | | | | | | | |
| Synergistic effect of reflectance | | — | Good | Good | Good | Good | Good |
| Appearance | | | Good | Good | Good | Good | Good |

| | | | Example | Example | Example | Example | Example |
|---|---|---|---|---|---|---|---|
| | | Unit | 23 | 24 | 25 | 26 | 27 |
| First section | Resin A | | A-1 | | A-1 | A-4 | A-1 |
| | Resin B | | B-3 | | B-5 | B-5 | B-5 |
| | Surface roughness | nm | 6.5 | | 6.5 | 6 | 6.5 |
| | Thickness of outermost | μ | 5 | | 5 | 5 | 5 |
| | layer | | | | | | |
| | Relative average | % | 59 | | 65 | 100 | |
| | reflectance | | | | | | |
| | Reflected color | — | Monochromatic | | Monochromatic | Metallic | Monochromatic |
| Second section | White film | — | D | | D | D | D |
| Transparent adhesive | Resin | — | IV | Air | IV | IV | |
| layer | Thickness | μm | | | 3 | 3 | |
| | Refractive index | — | 1.59 | 1 | 1.59 | 1.59 | 1.66 |
| Reflectance of specular | Absolute average | % | 58 | 57 | 66 | 98 | 68 |
| reflection component | reflectance at incidence | | | | | | |
| | angle of 20°/relative | | | | | | |
| | average reflectance | | | | | | |
| Absolute average | Rave (20°) | % | 57 | 55 | 65 | 100 | 67 |
| reflectance at incidence | | | | | | | |
| angle of 20° | | | | | | | |
| Relative average | Metallic: wavelength of | % | 97.5 | 96.5 | 98.5 | 102 | 99 |
| reflectance | 400 to 700 nm | | | | | | |
| | Monochromatic: | | (101.5) | (100) | (102) | | (102) |
| | wavelength of 450 to | | | | | | |
| | 550 nm | | | | | | |
| Glossiness | | | 745 | 741 | 771 | 912 | 780 |
| Colorimeter | Lightness L* (SCE) | — | 55 | 74 | 50 | 19 | 45 |
| Moldability | | — | Good | | Good | Good | Good |
| Rate of change in surface | | % | 9 | | 10 | 10 | 22 |
| roughness Ra | | | | | | | |
| Synergistic effect of reflectance | | — | Good | Good | Good | Good | Good |
| Appearance | | | Good | | Good | Good | Good |

TABLE 1-5

| | | Example | Example | Example | Example | Example | Example |
|---|---|---|---|---|---|---|---|
| | | 28 | 29 | 30 | 31 | 32 | 33 |
| | | Example | Example | Example | Example | Example | Example |
| Reflective film | Composition | 9 | 10 | 11 | 12 | 13 | 14 |
| First section | Resin A/Resin B | A-2/B-1 | | | A-1/B-3 | | |
| Second section | White film | D | E | F | D | E | F |
| Brightness | cd/m² | 285 | 281 | 263 | 272 | 267 | 262 |
| Rate of improvement | % | 107 | 106 | 100 | 102 | 101 | 100 |
| in brightness | | | | | | | |
| Evaluation | | Good | Good | Fair | Good | Good | Fair |

| | | Comparative | Example | Example | Example | Comparative |
|---|---|---|---|---|---|---|
| | | Example 8 | 34 | 35 | 36 | Example 9 |
| | | Comparative | Example | Example | Example | Comparative |
| Reflective film | Composition | Example 5 | 15 | 16 | 17 | Example 6 |
| First section | Resin A/Resin B | A-1/B-3 | | | A-1/B-3 | A-2/B-1 |
| Second section | White film | F | D | D | D | |
| Brightness | cd/m² | 240 | 257 | 247 | 235 | 259 |
| Rate of improvement | % | 92 | 96 | 93 | 88 | |
| in brightness | | | | | | |
| Evaluation | | Poor | Poor | Poor | Poor | Reference, no evaluation |

| | | Comparative | Comparative | Comparative | Comparative | Comparative |
|---|---|---|---|---|---|---|
| | | Example 10 | Example 11 | Example 12 | Example 13 | Example 14 |
| | | | | | | White film *) |
| | | Comparative | | | | (Thickness: |
| Reflective film | Composition | Example 7 | White film | White film | White film | 90 μm) |
| First section | Resin A/Resin B | A-1/B-3 | | | | A-1/B-3 |
| Second section | White film | | D | E | F | D |
| Brightness | cd/m² | 147 | 267 | 265 | 262 | 260 |
| Rate of improvement | % | | | | | |
| in brightness | | | | | | |

| | | |
|---|---|---|
| Evaluation | Reference, no evaluation | 97 |

*) Same film as Example 12 except for thickness

### INDUSTRIAL APPLICABILITY

Our reflective films can be used in liquid crystal display backlights, bulletin board systems, flash units of cellular phones and cameras, household electric appliances, automobiles, reflectors in lighting members of game consoles and the like, solar battery back sheets, and the like.

1.-15. (canceled)

16. A reflective film comprising:
a first section in which a layer comprising a resin A (A layer) and a layer comprising a resin B (B layer) are alternately laminated in 200 layers or more; and
a second section comprising a resin C which meets at least one of requirements (I) to (III), the two sections being arranged laminatedly in a thickness direction, wherein a relative average reflectance at a wavelength of 400 to 700 nm of light incident upon a first section side of the film arranged laminatedly is 70% or more, and reflectance of a specular reflection component is 10% or more of the relative average reflectance at a wavelength of 400 to 700 nm:
(I) voidage in the second section is 5% to 90%;
(II) content of inorganic particles in the second section is 5% by mass to 50% by mass; and
(III) content of organic particles in the second section is 3% by mass to 45% by mass.

17. The reflective film according to claim 16, wherein when two reflective films are arranged such that the first section and the second section are laminated, and a rate of change in surface roughness Ra of the first section before and after aging treatment at 60° C. for 24 hr under a load of 2 MPa is less than 100%.

18. The reflective film according to claim 16, further comprising a transparent layer provided between the first section and the second section arranged laminatedly, the transparent layer being a transparent adhesive layer having a thickness of 0.5 μm to 10 μm and a refractive index equal to or lower than the refractive index of air or of layers each forming an interface with the first section and the second section in contact with the transparent layer.

19. The reflective film according to claim 16, wherein a wavelength range where reflectance of light incident upon a surface at the first section side is higher than reflectance of light incident upon a surface at the second section side exists in the visible-light region.

20. The reflective film according to claim 16, wherein surface roughness of the first section and surface roughness of the second section at the interface arranged laminatedly are 20 nm or less and 35 nm or less, respectively.

21. The reflective film according to claim 16, wherein the second section has a three-layer structure in which an inner layer is a diffuse reflection layer, and outer layers have a thickness of 5 μm or more.

22. The reflective film according to claim 16, wherein one of the outermost layers of the first section has a thickness of 5 μm or more.

23. The reflective film according to claim 16, wherein the resin A comprises polyethylene terephthalate or polyethylene naphthalate.

24. The reflective film according to claim 16, wherein the resin A or the resin B is decalin acid copolyester.

25. The reflective film according to claim 16, wherein the resin C comprises polyethylene terephthalate and/or polyethylene terephthalate copolymer.

26. The reflective film according to claim 16, comprising the first section and the second section, wherein reflectance in the first section in a wavelength range of 400- to 700-nm reflection band is higher than reflectance in the second section in a wavelength range of 400- to 700-nm reflection band.

27. The reflective film according to claim 16, having a lightness L* (SCE) of 22 to 70.

28. The reflective film according to claim 16, having an absolute reflectance of 95% or more in a wavelength range of either 450 nm±30 nm or 550 nm±30 nm under conditions of a light incidence angle of 30° or more but less than 90°.

29. A reflecting plate for a liquid crystal display comprising the reflective film according to claim 16.

30. An LCD backlight system comprising an LED light source, the reflective film which has an absolute reflectance of 95% or more at a light incidence angle of 30° or more but less than 90° at a wavelength of a blue emission spectrum from the LED light source, a light guide plate, a light diffusing sheet, and a prism sheet, according to claim 16.
